(19) United States
(12) Patent Application Publication
(10) Pub. No.: US 2018/0139416 A1
(43) Pub. Date: May 17, 2018

(54) TRACKING SUPPORT APPARATUS, TRACKING SUPPORT SYSTEM, AND TRACKING SUPPORT METHOD

(71) Applicant: PANASONIC INTELLECTUAL PROPERTY MANAGEMENT CO., LTD., Osaka (JP)

(72) Inventors: Sonoko HIRASAWA, Kanagawa (JP); Takeshi FUJIMATSU, Kanagawa (JP)

(73) Assignee: PANASONIC INTELLECTUAL PROPERTY MANAGEMENT CO., LTD., Osaka (JP)

(21) Appl. No.: 15/572,395

(22) PCT Filed: Mar. 22, 2016
(86) PCT No.: PCT/JP2016/001627

§ 371 Date: Nov. 7, 2017

(30) Foreign Application Priority Data
May 26, 2015 (JP) 2015-106615

(51) Int. Cl. H04N 7/18; G06K 9/00; H04N 5/14

(52) U.S. Cl. CPC H04N 7/181; H04N 5/144; G06K 9/00771

(57) ABSTRACT

Tracking support apparatus includes: a tracking target setter that sets a moving object to be tracked by letting a monitoring person specify the moving object to be tracked on a video from a camera; a camera searcher that searches for a current tracing camera currently imaging the moving object to be tracked; a camera predictor that predicts a successive camera subsequently imaging the moving object to be tracked; a camera position presenter that displays a monitoring area map indicating a position of the current tracing camera; and a camera video presenter that displays a live video of each camera and highlights each live video of the current tracing camera and the successive camera. The camera position presentation unit and the camera video presentation unit display the monitoring area map and the live video of the camera in different display windows.

### TECHNICAL FIELD

The disclosure relates to a tracking support apparatus, a tracking support system, and a tracking support method that support a work of a monitoring person tracking a moving object to be tracked by displaying a live video of each a plurality of cameras imaging a monitoring area on a display apparatus.

### BACKGROUND ART

A monitoring system that a plurality of cameras is disposed in a monitoring area, a monitoring screen simultaneously displaying a live video of each of the plurality of cameras is displayed on a monitor, and a monitoring person monitors the screen is widely used. In the monitoring system, when finding a suspicious person on the monitoring screen, the monitoring person tracks the suspicious person while watching a video of each camera in the monitoring screen to monitor a future movement of the person.

In the case where the monitoring person tracks the suspicious person while watching the live video of each of the plurality of cameras on the monitoring screen, it is necessary to find a successive camera for subsequently imaging the person based on the advancing direction of the person to be monitored. However, when it takes time to find the successive camera, the person to be monitored is lost sight of. It is preferable to have a configuration capable of reducing a work burden of the monitoring person who finds the successive camera and smoothly tracking a person.

With respect to such a demand, in the related art, there is a known technique that a monitoring screen on which a plurality of display views respectively displaying a video of each of a plurality of cameras on a map image indicating a monitoring area is arranged corresponding to an actual arrangement state of cameras is displayed on a display apparatus, a display view on which a moving object set as a tracking target is subsequently imaged is predicted based on tracing information, and the display view is presented on the monitoring screen (refer to PTL 1).

### CITATION LIST

### Patent Literature

PTL 1: Japanese Patent No. 5506989

### SUMMARY OF THE INVENTION

In the related art, since the display view of each of the plurality of cameras is displayed on the map image corresponding to the actual arrangement state of cameras, it is possible to track a person with a video of a camera while grasping a positional relationship of cameras. Accordingly, it is easy to use and can greatly reduce a burden of a monitoring person performing the tracking work.

However, in the related art, it may be difficult to satisfy both of, depending on the number or arrangement state of cameras, displaying a video with an appropriate size in a display view and displaying the display view such that the positional relationship of cameras can be identified. That is, when the number of cameras increases, the number of display views increases. In the case, when a video with an appropriate size is displayed in the display view, the map image is hidden in the increased number of display views, and the display views cannot be arranged so as to correspond to the actual arrangement state of cameras. Consequently, there is a problem that the positional relationship of cameras cannot be grasped sufficiently.

The present disclosure is devised to solve such problems in the related art. The main purpose of the present disclosure is to provide a tracking support apparatus, a tracking support system, and a tracking support method configured to make it possible to reduce the work burden of the monitoring person who is tracking the person while watching a video of each camera without being limited by the number of the cameras and the arrangement state of the cameras and to continue tracking without losing sight of the person to be tracked.

A tracking support apparatus according to the present disclosure is configured to support a work of a monitoring person tracking a moving object to be tracked by displaying a live video of each of a plurality of cameras imaging a monitoring area on a display apparatus. The apparatus includes: a tracking target setting unit that sets the moving object to be tracked in response to an input operation of the monitoring person for displaying the video of the camera on the display apparatus and for specifying the moving object to be tracked on the videos; a camera search unit that searches for a current tracing camera currently imaging the moving object to be tracked based on tracing information acquired by tracing processing with respect to the video of the camera; a camera prediction unit that predicts a successive camera subsequently imaging the moving object to be tracked based on the tracing information; a camera position presentation unit that displays a monitoring area map indicating a position of the current tracing camera on the display apparatus; and a camera video presentation unit that displays the live video for each of the plurality of cameras and highlights each live video of the current tracing camera and the successive camera in an identifiable manner different from live videos of other cameras. The camera position presentation unit and the camera video presentation unit display the monitoring area map and the live video of the camera in different display windows on the display apparatus and update the position of the current tracing camera on the monitoring area map and each highlighted live video of the current tracing camera and the successive camera corresponding to switching of the current tracing camera.

A tracking support system according to the present disclosure is configured to support a work of a monitoring person tracking a moving object to be tracked by displaying a live video of each of a plurality of cameras imaging a monitoring area on a display apparatus. The system includes the camera for imaging the monitoring area, the display apparatus for displaying a video of each camera, and a plurality of information processing apparatuses. Any one of the plurality of information processing apparatuses includes: a tracking target setting unit that sets the moving object to be tracked in response to an input operation of the monitoring person for displaying the video of the camera on the display apparatus and for specifying the moving object to be tracked on the videos; a camera search unit that searches for a current tracing camera currently imaging the moving object to be tracked based on tracing information acquired by tracing processing with respect to the video of the camera; a camera prediction unit that predicts a successive camera subsequently imaging the moving object to be tracked based on the tracing information; a camera position presentation unit that displays a monitoring area map indicating a position of the current tracing camera on the display apparatus; and a camera video presentation unit that displays the live video for each of the plurality of cameras and highlights each live video of the current tracing camera and the successive camera in an identifiable manner different from live videos of other cameras. The camera position presentation unit and the camera video presentation unit display the monitoring area map and the live video of the camera in different display windows on the display apparatus and update the position of the current tracing camera on the monitoring area map and each highlighted live video of the current tracing camera and the successive camera corresponding to switching of the current tracing camera.

A tracking support method according to the present disclosure is configured to cause an information processing apparatus to perform processing for supporting a work of a monitoring person tracking a moving object to be tracked by displaying a live video of each of a plurality of cameras imaging a monitoring area on a display apparatus. The method includes: a step of setting the moving object to be tracked in response to an input operation of the monitoring person for displaying the video of the camera on the display apparatus and for specifying the moving object to be tracked on the videos; a step of searching for a current tracing camera currently imaging the moving object to be tracked based on tracing information acquired by tracing processing with respect to the video of the camera; a step of predicting a successive camera subsequently imaging the moving object to be tracked based on the tracing information; a step of displaying a monitoring area map indicating a position of the current tracing camera on the display apparatus; and a step of displaying the live video for each of the plurality of cameras and highlights each live video of the current tracing camera and the successive camera in an identifiable manner different from live videos of other cameras. In each step of displaying the monitoring area map and the live video of the camera on the display apparatus, the monitoring area map and the live video of the camera are displayed in different display windows on the display apparatus, and the position of the current tracing camera on the monitoring area map and each highlighted live video of the current tracing camera and the successive camera are updated corresponding to switching of the current tracing camera.

According to the present disclosure, since the video of the current tracing camera in which the moving object to be tracked is imaged and the video of the successive camera predicted that the moving object to be tracked is imaged subsequently are highlighted, and the monitoring area map and the video of the camera are displayed in different display windows on the display apparatus, it is possible to greatly reduce the burden of the monitoring person performing the tracking work without being limited by the number of the cameras and the arrangement state of the cameras and to continue tracking without losing sight of the moving object to be tracked.

### BRIEF DESCRIPTION OF DRAWINGS

FIG. 1 is an overall configuration diagram of a tracking support system according to a first embodiment.

FIG. 2 is a plan view illustrating an installation state of camera 1 in a store.

FIG. 3 is a functional block diagram illustrating a schematic configuration of PC 3.

FIG. 4 is an explanatory diagram illustrating a transition state of screens displayed on monitor 7.

FIG. 5 is a flow diagram illustrating a processing procedure performed in each unit of PC 3 in response to an operation of a monitoring person performed on each screen.

FIG. 6 is an explanatory diagram illustrating a person search screen displayed on monitor 7.

FIG. 7 is an explanatory diagram illustrating a person search screen displayed on monitor 7.

FIG. 8 is an explanatory diagram illustrating a camera selection screen displayed on monitor 7.

FIG. 9 is an explanatory diagram illustrating a monitoring area map screen displayed on monitor 7.

FIG. 10 is an explanatory diagram illustrating a video list display screen displayed on monitor 7.

FIG. 11 is an explanatory diagram illustrating a video list display screen displayed on monitor 7.

FIG. 12 is an explanatory diagram illustrating a magnified video display screen displayed on monitor 7.

FIG. 13 is an explanatory diagram illustrating a transition state of screens displayed on monitor 7 according to a second embodiment.

FIG. 14 is an explanatory diagram illustrating a person search screen displayed on monitor 7.

FIG. 15 is an explanatory diagram illustrating a person search screen displayed on monitor 7.

FIG. 16 is an explanatory diagram illustrating a camera selection screen displayed on monitor 7.

FIG. 17 is an explanatory diagram illustrating a video list display screen displayed on monitor 7.

FIG. 18 is an explanatory diagram illustrating a video list display screen displayed on monitor 7.

### DESCRIPTION OF EMBODIMENTS

A first disclosure made to solve the above problems is configured that a tracking support apparatus supports a work of a monitoring person tracking a moving object to be tracked by displaying a live video of each of a plurality of cameras imaging a monitoring area on a display apparatus. The apparatus includes: a tracking target setting unit that sets the moving object to be tracked in response to an input operation of the monitoring person for displaying the video of the camera on the display apparatus and for specifying the moving object to be tracked on the videos; a camera search unit that searches for a current tracing camera currently imaging the moving object to be tracked based on tracing information acquired by tracing processing with respect to the video of the camera; a camera prediction unit that predicts a successive camera subsequently imaging the moving object to be tracked based on the tracing information; a camera position presentation unit that displays a monitoring area map indicating a position of the current tracing camera on the display apparatus; and a camera video presentation unit that displays the live video for each of the plurality of cameras on the display apparatus and highlights each live video of the current tracing camera and the successive camera in an identifiable manner different from live videos of other cameras. The camera position presentation unit and the camera video presentation unit display the monitoring area map and the live video of the camera in different display windows on the display apparatus and update the position of the current tracing camera on the monitoring area map and each highlighted live video of the current tracing camera and the successive camera corresponding to switching of the current tracing camera.

Consequently, since the video of the current tracing camera in which the moving object to be tracked is imaged and the video of the successive camera predicted that the moving object to be tracked is imaged subsequently are highlighted, and the monitoring area map and the video of the camera are displayed in different display windows on the display apparatus, it is possible to greatly reduce the burden of the monitoring person performing the tracking work without being limited by the number of the cameras and the arrangement state of the cameras and to continue tracking without losing sight of the moving object to be tracked.

A second disclosure is configured that the tracking target setting unit sets a moving object to be tracked on a video displayed in response to an input operation for specifying a time and a camera by a monitoring person in a person search screen.

Consequently, it is possible to find the video in which the person to be tracked is imaged from the person search screen based on the place and the time at which the person to be tracked, memorized by the monitoring person, is found.

A third disclosure is configured to further include a tracking target presentation unit that displays a mark representing the moving object detected from the video of the camera on the live video of the camera based on the tracing information and highlights the mark of the person to be tracked in an identifiable manner different from the marks of other persons, and, in a case where there is an error in the highlighted mark, the tracking target setting unit causes a monitoring person to select the mark of the correct moving object as the tracking target among the videos of all the cameras so as to change the moving object selected by the monitoring person to the tracking target.

Consequently, in the case where there is the error in the moving object presented as the tracking target by the tracking target presentation unit, by changing the moving object to be tracked, the moving object to be tracked is imaged certainly in the video of the current tracing camera thereafter, and it is possible to continue tracking without losing sight of the moving object to be tracked

A fourth disclosure is configured to still further include a setting information holder that holds information on a degree of relevance representing a level of relevance between the two cameras, and the camera video presentation unit arranges the videos of other cameras according to the degree of relevance between the current tracing camera and other cameras based on the video of the current tracing camera on the screen of the display apparatus displaying video of each of the plurality of the cameras.

Consequently, since the videos of the cameras other than the current tracing camera are arranged according to the degree of relevance based on the video of the current tracing camera, even in a case of losing sight of the moving object to be tracked in the video of current tracing camera, it is possible to easily find the video of the camera in which the moving object to be tracked is imaged.

A fifth disclosure is configured that the camera video presentation unit can increase or decrease the number of the cameras for simultaneously displaying videos on the screen of the display apparatus corresponding to the number of the cameras having a high degree of relevance with the current tracing camera.

Consequently, since it is possible to increase or decrease the number of cameras for simultaneously displaying videos on the screen of the display apparatus (the number of displayed cameras), it is possible to display the videos of the cameras by the necessary number of cameras. In the case, the monitoring person may manually select the number of displayed cameras as necessary, or the number of displayed cameras may be switched automatically based on the number of cameras having the high degree of relevance with the current tracing camera in the camera video presentation unit.

A sixth disclosure is configured that, in a case where a total number of the cameras installed at the monitoring area exceeds the number of cameras for simultaneously displaying videos on the screen of the display apparatus, the camera video presentation unit selects the cameras having the high degree of relevance with the current tracing camera by the number of cameras to be displayed simultaneously, and displays the videos of the cameras on the screen of the display apparatus.

Consequently, since the moving object to be tracked suddenly does not move from the imaging area of the current tracing camera to the camera having the low degree of relevance with the current tracing camera, that is, the imaging area of the camera far away from the current tracing camera, it is possible to continue tracking without losing sight of the moving object to be tracked by displaying only videos of cameras having the high degree of relevance with the current tracing camera.

A seventh disclosure is configured that the camera video presentation unit displays the videos of the cameras on the screen of the display apparatus side by side in vertical and horizontal directions and arranges the videos of other cameras with the video of the current tracing camera as a center around the video of the current tracing camera corresponding to an actual positional relationship between the cameras.

Consequently, since the video of the current tracing camera is arranged at the center, the monitoring person can easily check the moving object to be tracked. Since the video of the camera other than the current tracing camera is arranged around the video of the current tracing camera in correspondence with the actual positional relationship of the camera, even in a case of losing sight of the moving object to be tracked in the video of the current tracing camera, it is possible to easily find the video of the camera in which the moving object to be tracked is imaged.

An eighth disclosure is configured that, in response to an input operation of a monitoring person for selecting any one of the live videos for each camera displayed on the display apparatus, the camera video presentation unit displays the live video of the camera in a magnified manner on the display apparatus.

Consequently, since the video of the camera is displayed in a magnified manner, it is possible to observe the situation of the moving object to be tracked in detail.

A ninth disclosure is configured that a tracking support system supports a work of a monitoring person tracking a moving object to be tracked by displaying a live video of each of a plurality of cameras imaging a monitoring area on a display apparatus. The system includes the camera for imaging the monitoring area, the display apparatus for displaying a video of each camera, and a plurality of information processing apparatuses. Any one of the plurality of information processing apparatuses includes: a tracking target setting unit that sets the moving object to be tracked in response to an input operation of the monitoring person for displaying the video of the camera on the display apparatus and for specifying the moving object to be tracked on the videos; a camera search unit that searches for a current tracing camera currently imaging the moving object to be tracked based on tracing information acquired by tracing processing with respect to the video of the camera; a camera prediction unit that predicts a successive camera subsequently imaging the moving object to be tracked based on the tracing information; a camera position presentation unit that displays a monitoring area map indicating a position of the current tracing camera on the display apparatus; and a camera video presentation unit that displays the live video for each of the plurality of cameras on the display apparatus and highlights each live video of the current tracing camera and the successive camera in an identifiable manner different from live videos of other cameras. The camera position presentation unit and the camera video presentation unit display the monitoring area map and the live video of the camera in different display windows on the display apparatus and update the position of the current tracing camera on the monitoring area map and each highlighted live video of the current tracing camera and the successive camera corresponding to switching of the current tracing camera.

Consequently, similarly to the first disclosure, the work burden of the monitoring person who is tracking the person while watching the video of each of the plurality of cameras can be reduced without being limited by the number of the cameras and the arrangement state of the cameras, and the monitoring person can continue tracking without losing sight of the person to be tracked.

A tenth disclosure is configured that a tracking support method causes an information processing apparatus to perform processing for supporting a work of a monitoring person tracking a moving object to be tracked by displaying a live video of each of a plurality of cameras imaging a monitoring area on a display apparatus. The method includes: a step of setting the moving object to be tracked in response to an input operation of the monitoring person for displaying the video of the camera on the display apparatus and for specifying the moving object to be tracked on the videos; a step of searching for a current tracing camera currently imaging the moving object to be tracked based on tracing information acquired by tracing processing with respect to the video of the camera; a step of predicting a successive camera subsequently imaging the moving object to be tracked based on the tracing information; a step of displaying a monitoring area map indicating a position of the current tracing camera on the display apparatus; and a step of displaying the live video for each of the plurality of cameras on the display apparatus and highlighting each live video of the current tracing camera and the successive camera in an identifiable manner different from live videos of other cameras. In each step of displaying the monitoring area map and the live video of the camera on the display apparatus, the monitoring area map and the live video of the camera are displayed in different display windows on the display apparatus, and the position of the current tracing camera on the monitoring area map and each highlighted live video of the current tracing camera and the successive camera are updated corresponding to switching of the current tracing camera.

Consequently, similarly to the first disclosure, the work burden of the monitoring person who is tracking the person while watching the video of each of the plurality of cameras can be reduced without being limited by the number of the cameras and the arrangement state of the cameras, and the monitoring person can continue tracking without losing sight of the person to be tracked.

Hereinafter, exemplary embodiments of the present disclosure will be described with reference to drawings. In the description of the present exemplary embodiments, terms of “tracking” and “tracing” with similar meaning are used merely for the sake of convenience of explanation. The “tracking” is used mainly in a case of having a strong relationship with the act of a monitoring person, and the “tracing” is used mainly in a case of having a strong relationship with processing performed by an apparatus.

### First Exemplary Embodiment

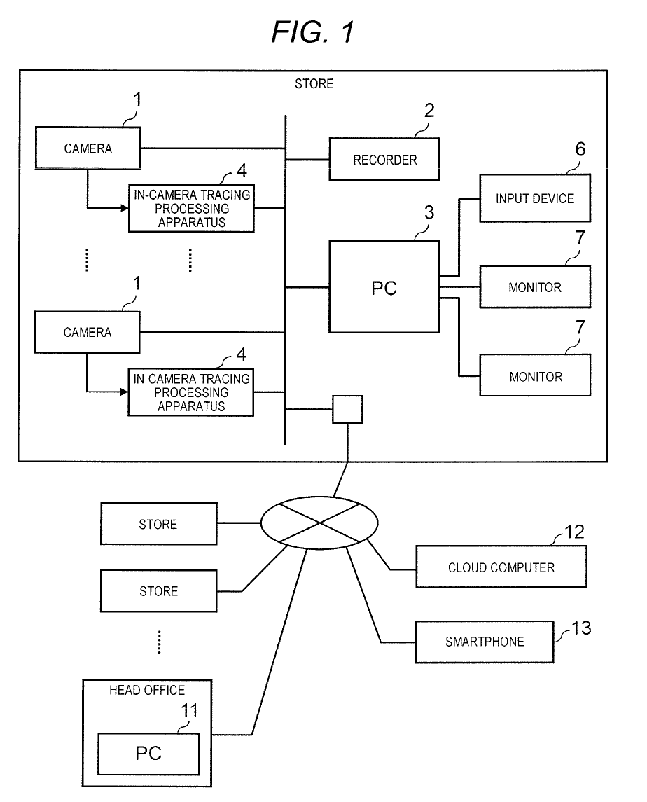

FIG. 1 is an overall configuration diagram of a tracking support system according to a first exemplary embodiment. The tracking support system is built for a retail store such as supermarket and DIY store and includes camera 1, recorder (video storage) 2, PC (tracking support apparatus) 3, and in-camera tracing processing apparatus 4.

Camera 1 is installed at an appropriate place in a store, the inside of the store (monitoring area) is imaged by camera 1, and a video of the inside of the store imaged by camera 1 is recorded in recorder 2.

PC 3 is connected to input device 6 such as a mouse for performing various input operations by a monitoring person (for example, security guard) and a monitor (display apparatus) 7 for displaying a monitoring screen. PC 3 is installed at security office of the store or the like. The monitoring person can view, on the monitoring screen displayed on monitor 7, the video (live video) of the inside of the store imaged by camera 1 in real time and a video of the inside of the store imaged in the past recorded in recorder 2.

PC 11 installed at the head office is connected to a monitor (not illustrated). It is possible to check a state of the inside of the store at the head office by viewing the video of the inside of the store imaged by camera 1 in real time and a video of the inside of the store imaged in the past recorded in recorder 2.

In-camera tracing processing apparatus 4 performs processing for tracing a person (moving object) detected from a video of camera 1 and generating in-camera tracing information for each person. A known image recognition technique (for example, person detection technique and person tracking technique) can be used for in-camera tracing processing.

In the exemplary embodiment, in-camera tracing processing apparatus 4 continuously performs the in-camera tracing processing independently from PC 3, but may perform the tracing processing in response to an instruction from PC 3. In in-camera tracing processing apparatus 4, it is preferable to perform the tracing processing for all persons detected from a video, but the tracing processing may be performed only for a person specified as a tracking target and a person having the high level of relevance with the specified person.

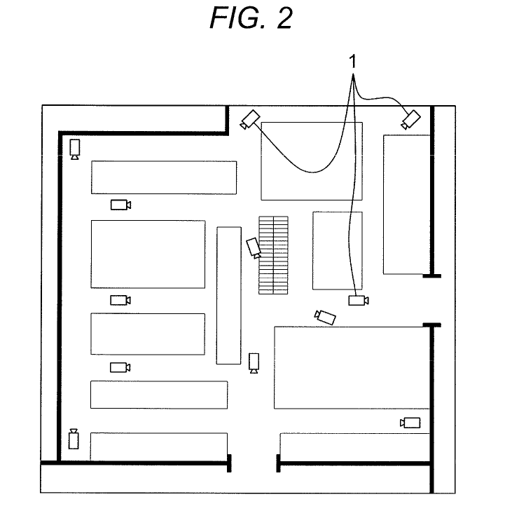

Next, an installation state of camera 1 in the store illustrated in FIG. 1 will be described. FIG. 2 is a plan view illustrating the installation state of camera 1 in the store.

In the store (monitoring area), passages are provided between commodity display spaces, and a plurality of cameras 1 is installed so as to mainly image the passages. When a person moves in a passage in the store, any one of the cameras 1 or the plurality of cameras 1 images the person, and, according to a movement of the person, a subsequent camera 1 images the person.

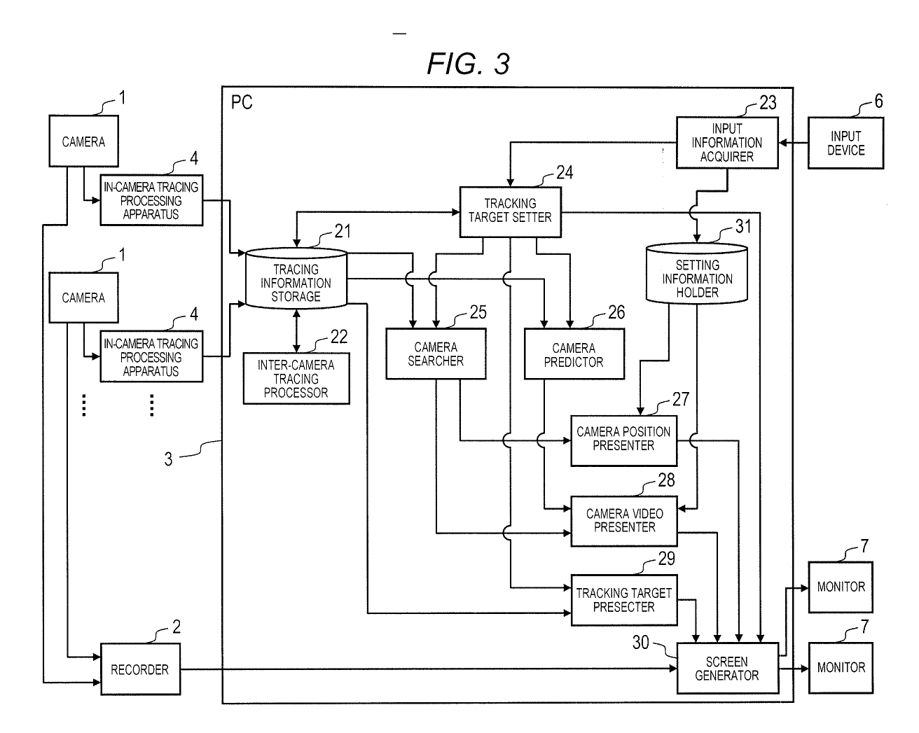

Next, a schematic configuration of PC 3 illustrated in FIG. 1 will be described. FIG. 3 is a functional block diagram illustrating the schematic configuration of PC 3.

PC 3 includes tracing information storage 21, inter-camera tracing processor 22, input information acquirer 23, tracking target setter 24, camera searcher 25, camera predictor 26, camera position presenter 27, camera video presenter 28, tracking target presenter 29, screen generator 30, and setting information holder 31.

In tracing information storage 21, the in-camera tracing information generated by in-camera tracing processing apparatus 4 is accumulated. In tracing information storage 21, in-camera tracing information generated by inter-camera tracing process 22 is accumulated.

Inter-camera tracing processor 22 calculates a link score (evaluation value) representing the degree of possibility of being the same person among persons detected by the in-camera tracing processing based on the tracing information (in-camera tracing information) accumulated in tracing information storage 21. The processing calculates the link score based on, for example, detection time of the person (imaging time of a frame), detection position of the person, moving speed of the person, and color information of an image of the person. The information on the link score calculated by inter-camera tracing processor 22 is accumulated in tracing information storage 21 as the inter-camera tracing information.

Input information acquirer 23 performs processing for acquiring input information based on an input operation in response to the input operation of the monitoring person using input device 6 such as the mouse.

Tracking target setter 24 performs processing for displaying a person search screen (tracking target search screen) in which the past video accumulated in recorder 2 or the live video output from camera 1 is displayed on monitor 7, causing the monitoring person to specify the person to be tracked on the person search screen, and setting the specified person as the tracking target. In the exemplary embodiment, a person frame (mark) representing the person detected from a video of camera 1 is displayed on the video of the camera, and the person frame is selected to set the person as the tracking target.

Camera searcher 25 searches for a current tracing camera 1 that currently images the person set as the tracking target by tracking target setter based on tracing information (inter-camera tracing information) accumulated in tracing information storage 21. In the processing, based on the person set as the tracking target, a person having the highest link score among persons detected and traced by the in-camera tracing processing is subsequently selected for each camera 1, and the latest tracing position of the person to be tracked is acquired, and camera 1 corresponding to the latest tracing position is set as the current tracing camera 1.

Camera predictor 26 predicts a successive camera 1 for subsequently imaging the person set as the tracking target by tracking target setter 24 based on the tracing information (in-camera tracing information) accumulated in tracing information storage 21. In the processing, a moving direction of the person to be tracked and a positional relationship between the person to be tracked and an imaging area of camera 1 are acquired from the in-camera tracing information and positional information on the imaging area of camera 1, and the successive camera 1 is predicted based on the moving direction and the positional relationship.

Camera position presenter 27 presents a position of a current tracing camera 1 searched by camera searcher 25 to the monitoring person. In the exemplary embodiment, a monitoring area map indicating the position of the current tracing camera 1 on a map image representing a state of a monitoring area is displayed on monitor 7. The monitoring area map represents an installation state of cameras 1 in the monitoring area. Positions of all the cameras 1 installed at the monitoring area are displayed on the monitoring area map, and, in particular, the current tracing camera 1 is highlighted in an identifiable manner from other cameras 1.

Camera video presenter 28 presents, to the monitoring person, each live video (current video) of the current tracing camera 1 searched by camera searcher 25 and the successive camera 1 predicted by camera predictor 26. In the exemplary embodiment, the live video of each camera 1 is displayed on monitor 7, and the live videos of the current tracing camera 1 and the successive camera 1 are highlighted in an identifiable manner from the live videos of other cameras 1. Specifically, a frame image subjected to predetermined coloring is displayed at the peripheral portion of a video display frame displaying the live videos of the current tracing camera 1 and the successive camera 1 as the highlighted display.

Here, camera position presenter 27 and camera video presenter 28 display the monitoring area map and the video of camera 1 in different display windows on monitor 7. For example, a display window displaying the monitoring area map and a display window displaying the video of camera 1 are displayed separately in two monitors 7. The display window displaying the monitoring area map and the display window displaying the video of the camera may be displayed on one monitor 7 so as not to overlap each other.

When the person moves from the imaging area of the current tracing camera 1 to an imaging area of another camera 1, camera position presenter 27 and camera video presenter 28 updates the position of the current tracing camera 1 on the monitoring area map and each highlighted live video of the current tracing camera 1 and the successive camera 1 according to switching of the current tracing camera 1.

Camera video presenter 28 arranges videos of other cameras 1 based on the video of the current tracing camera 1 on the screen of monitor 7 displaying video of each of the plurality of cameras 1 according to the degree of relevance between the current tracing camera 1 and other cameras 1. In the exemplary embodiment, the videos of cameras 1 are displayed on the screen of monitor 7 side by side in the vertical and horizontal directions, and the videos of other cameras 1 with the video of the current tracing camera 1 as the center are arranged around the video of the current tracing camera 1 corresponding to an actual positional relationship with the current tracing camera 1.

Here, the degree of relevance represents the level of relevance between two cameras 1 and is set based on a positional relationship between the two cameras 1. That is, in a case where a separation distance between the two cameras 1 is small, the degree of relevance becomes high. In a case where the separation distance between the two cameras 1 is large, the degree of relevance becomes low. The separation distance between the two cameras 1 may be the straight line distance of an installation position of the two cameras 1 or a separation distance on a route on which a person can move. In such case, even when the straight line distance of the installation position of the two cameras 1 is small, in the case where the person takes a detour to move, the separation distance between the two cameras 1 becomes large.

In the exemplary embodiment, it is possible to increase or decrease the number of cameras 1 (the number of displayed cameras) for simultaneously displaying videos on the screen of monitor 7 corresponding to the number of cameras 1 having the high degree of relevance with the current tracing camera 1. In the exemplary embodiment, the monitoring person can select the number of displayed cameras from nine or twenty-five cameras. In a case where the total number of cameras 1 installed at the monitoring area exceeds the number of displayed cameras, cameras 1 having the high degree of relevance with the current tracing camera 1 are selected by the number of displayed cameras and videos of the selected cameras 1 are displayed on the screen of monitor 7.

Tracking target presenter 29 presents the person to be tracked on the video of the current tracing camera 1 to the monitoring person based on tracing information (in-camera tracing information) accumulated in tracing information storage 21. In the exemplary embodiment, the person frame (mark) representing the person to be traced is displayed on the person detected by the in-camera tracing processing from the video of each camera 1, and, in particular, the person frame of the person to be tracked is highlighted in an identifiable manner from the person frames of other persons. Specifically, the person frame of the person to be tracked is displayed in a color different from the person frames of other persons as the highlighted display.

Here, in a case where there is an error in a person presented as the tracking target by tracking target presenter 29, that is, the person frame highlighted on the video of the current tracing camera 1 is displayed on a person different from the person to be tracked, the monitoring person selects the person frame of the person to be tracked among videos of all the cameras 1, and tracking target setter 24 performs processing for changing the person selected by the monitoring person to the tracking target.

With the processing for changing the tracking target, inter-camera tracing processor 22 may correct tracing information on the person who is changed to the tracking target and the person who is erroneously recognized as the person to be tracked. In the manner, by correcting the tracing information, in a case of checking the action of the person after an incident, it is possible to appropriately display the video of the person to be tracked based on the correct tracing information.

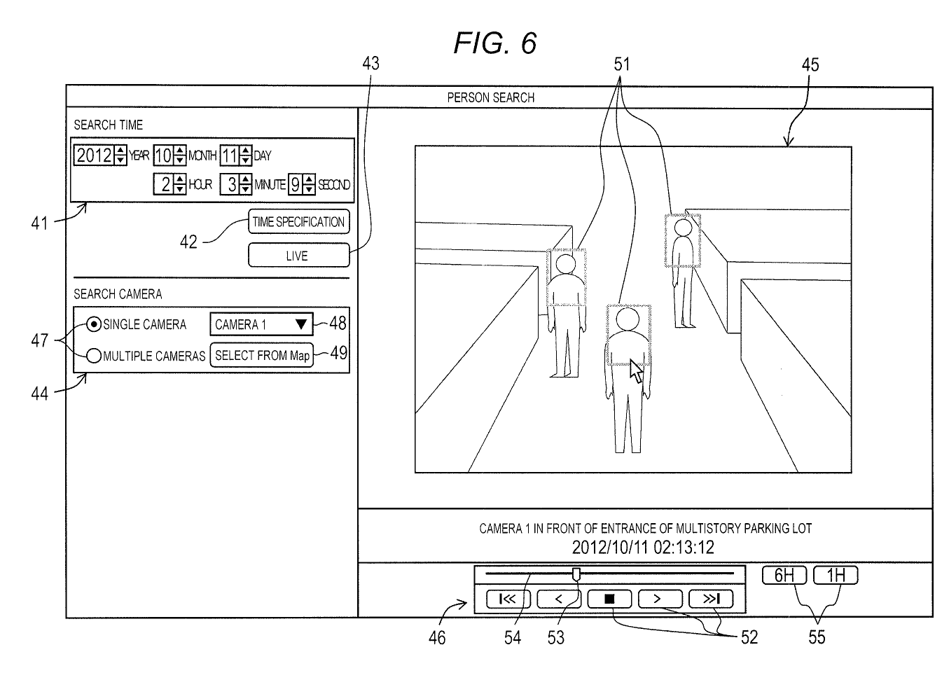

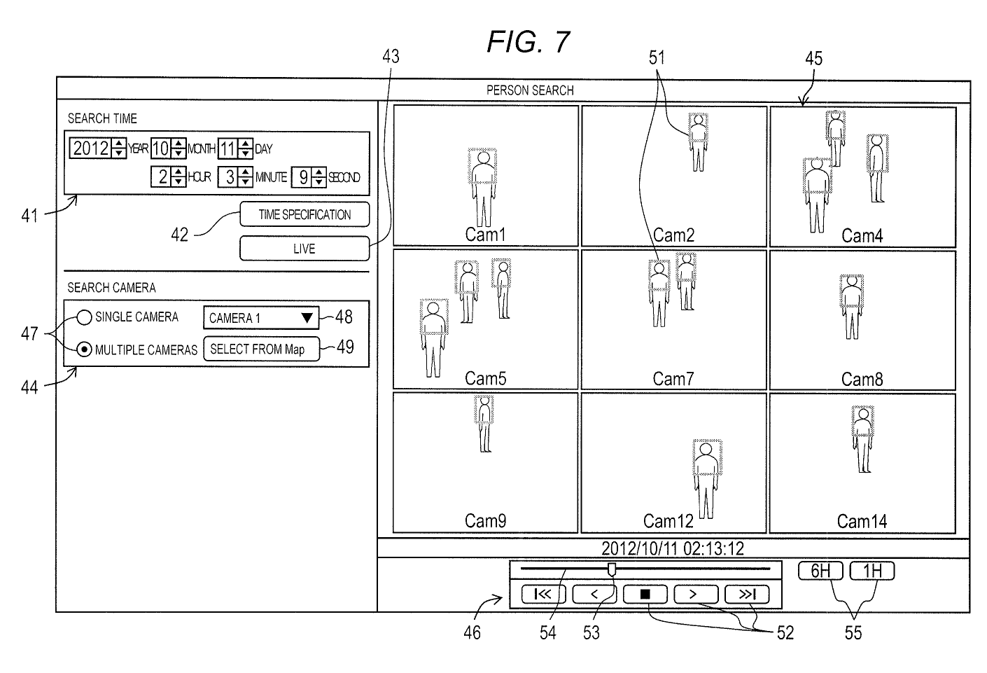

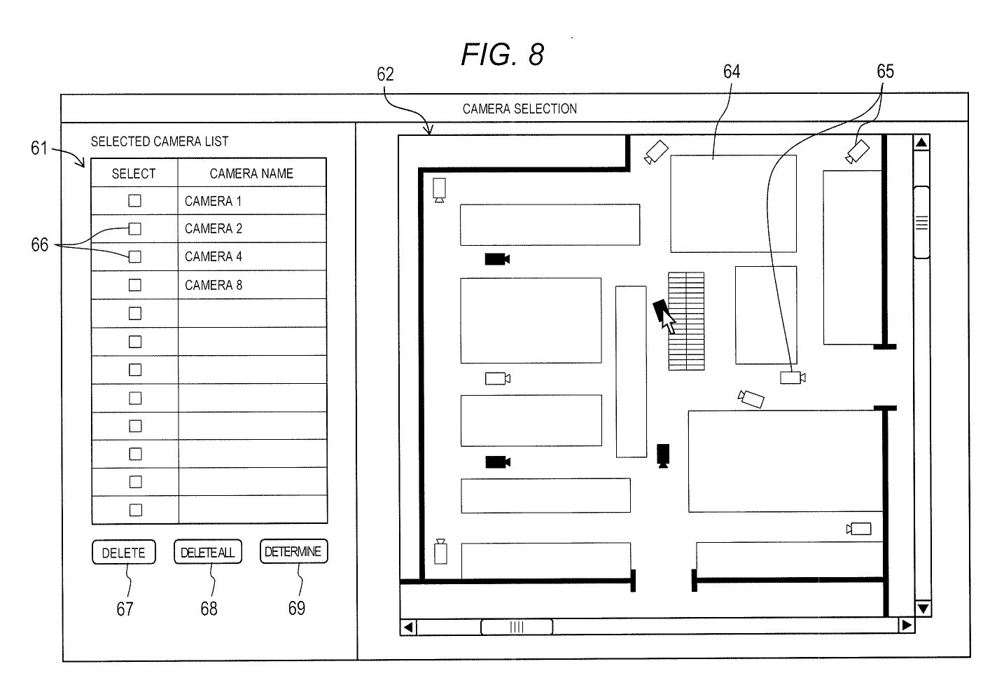

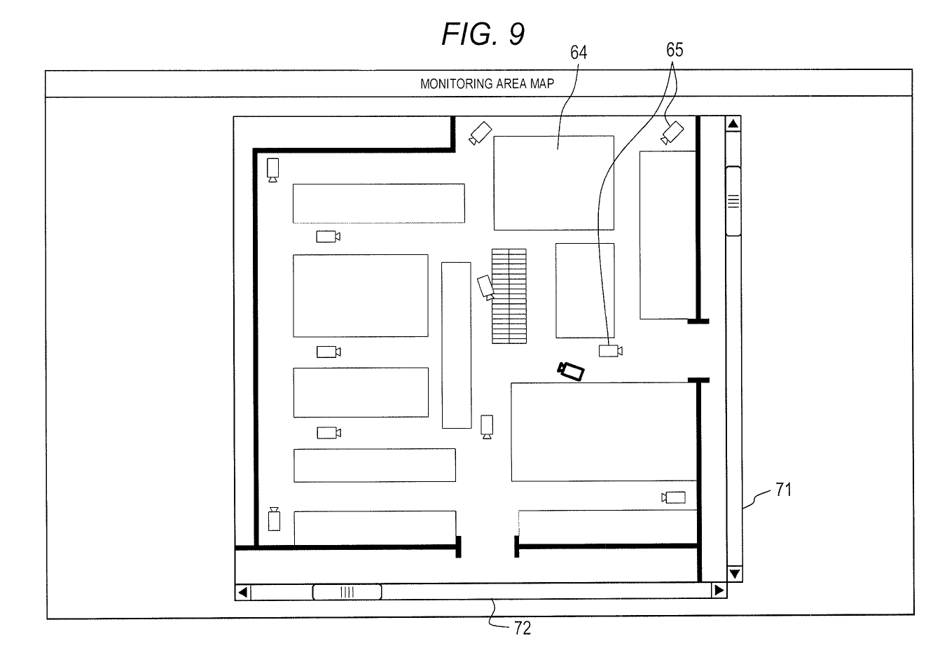

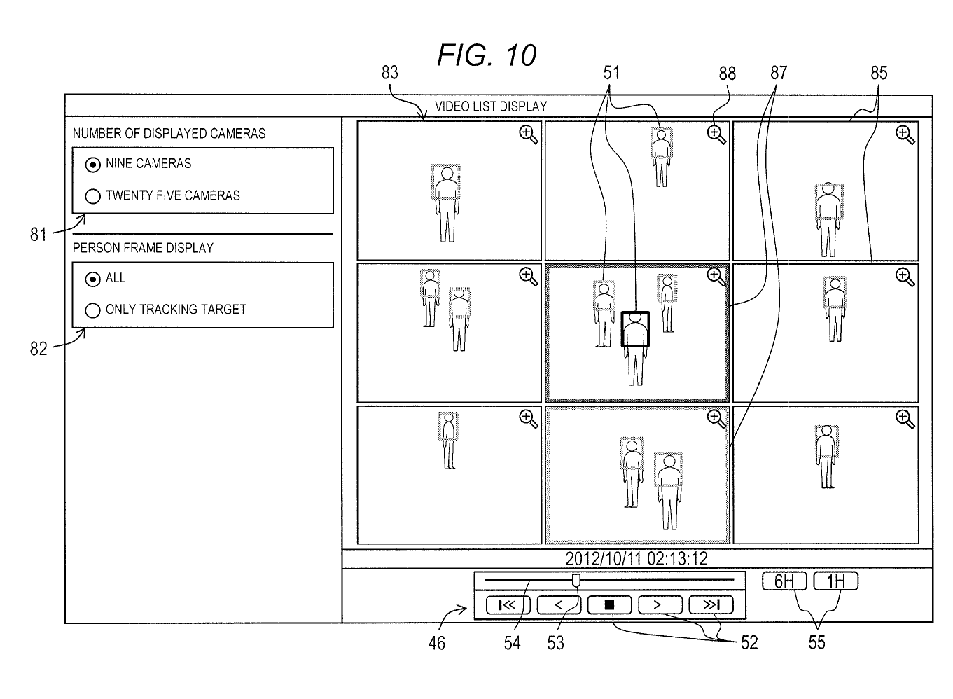

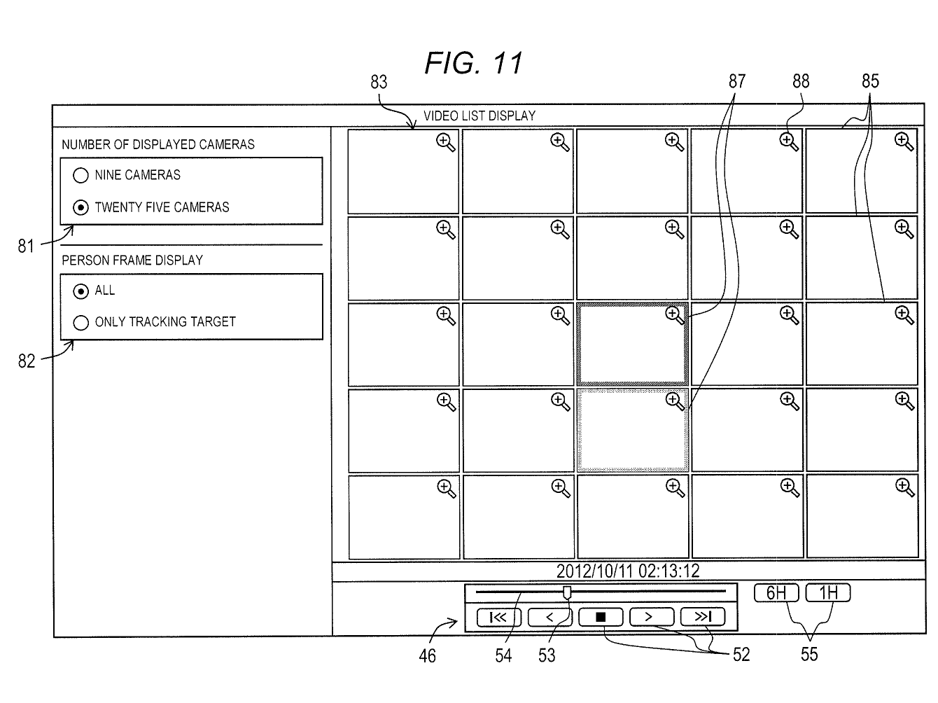

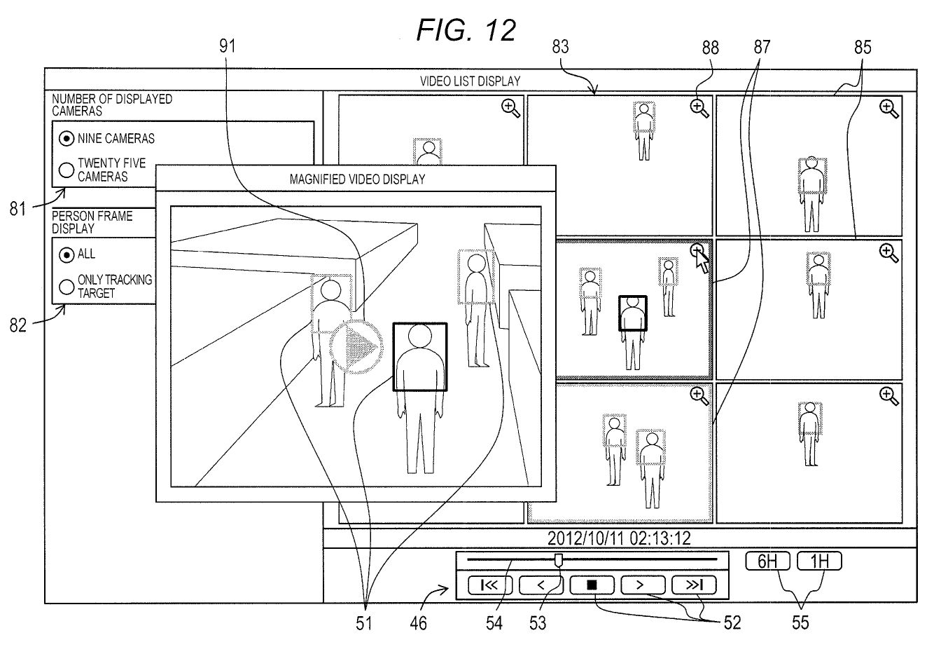

Screen generator 30 generates display information on the screen to be displayed on monitor 7. In the exemplary embodiment, display information of the person search screen (refer to FIGS. 6 and 7) and a camera selection screen (refer to FIG. 8) is generated in response to an instruction from tracking target setter 24, display information of a monitoring area map screen (refer to FIG. 9) is generated in response to an instruction from camera position presenter 27, and display information of a video list display screen (refer to FIGS. 10 and 11) and a magnified video display screen (refer to FIG. 12) is generated in response to an instruction from camera video presenter 28.

Setting information holder 31 holds setting information used in various processing performed in PC. In the exemplary embodiment, setting information holder 31 holds information such as identification information of camera 1 (camera ID), the name of camera 1, coordinate information on an installation position of camera 1, a map image indicating a monitoring area, and an icon of camera 1. In the exemplary embodiment, information on the degree of relevance representing the level of relevance between cameras 1 is set in advance for each camera 1 in response to the input operation of a user or the like, and the information on the degree of relevance is held in setting information holder 31.

Each unit of PC 3 illustrated in FIG. 3 is realized by causing a processor (CPU) of PC 3 to execute programs (instructions) for tracking support stored in a memory such as an HDD. Such programs may be provided to the user by installing the programs in advance in PC 3, as an information processing apparatus, configured as a dedicated apparatus, by recording the programs in an appropriate program recording medium as an application program operated on a predetermined OS, or through a network.

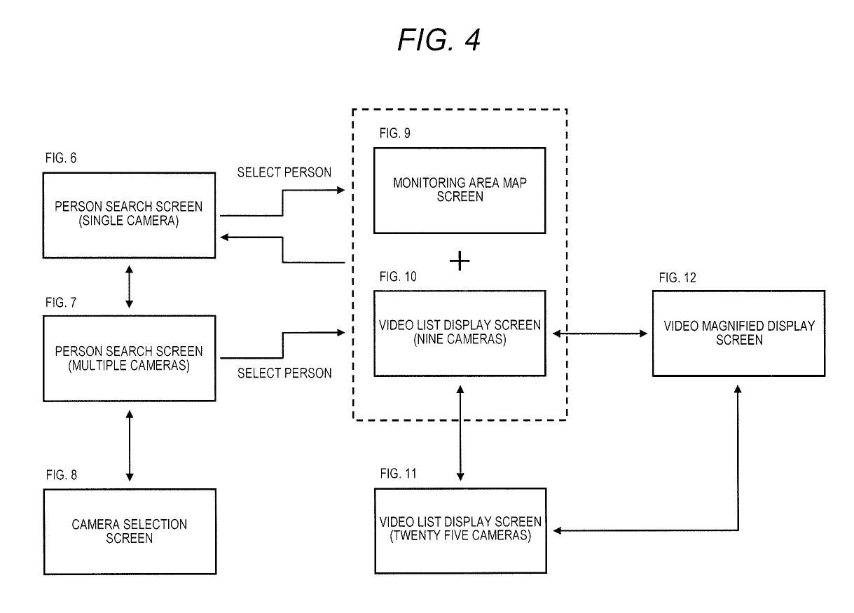

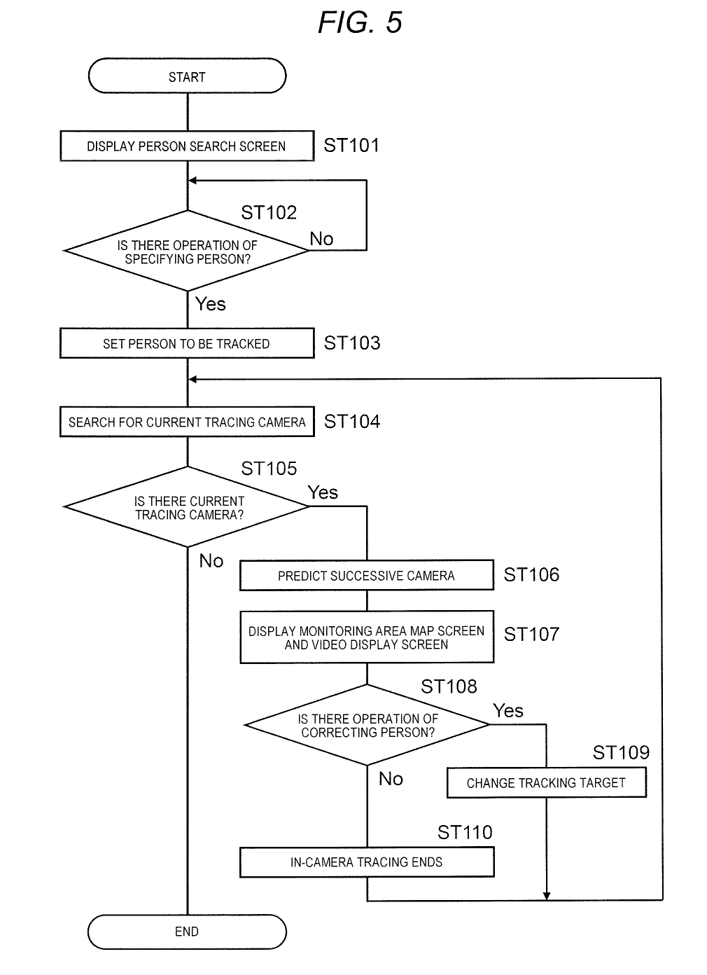

Next, each screen displayed on monitor 7 illustrated in FIG. 1 and the processing performed in each unit of PC 3 in response to the operation of the monitoring person performed on each screen will be described. FIG. 4 is an explanatory diagram illustrating a transition state of screens displayed on monitor 7. FIG. 5 is a flow diagram illustrating a processing procedure performed in each unit of PC 3 in response to the operation of the monitoring person performed on each screen.

First, when an operation to start tracking support processing is performed in PC 3, tracking target setter 24 performs processing for displaying the person search screen (refer to FIGS. 6 and 7) on monitor 7 (ST 101). The person search screen by a single camera displays a video of the single camera 1 to find a video in which the person to be tracked is imaged, and a person search screen by a plurality of cameras displays videos of the plurality of cameras 1 to find the video in which the person to be tracked is imaged.

Here, when an operation of a camera selection is performed on the person search screen by the plurality of cameras, the screen transitions to the camera selection screen (refer to FIG. 8). In the camera selection screen, the monitoring person can select a plurality of cameras 1 for displaying videos on the person search screen. In the camera selection screen, when camera 1 is selected, the screen returns to the person search screen, and a video of the selected camera is displayed on the person search screen.

The person search screen displays a person frame for each person detected by the in-camera tracing processing in the displayed videos. When the person to be tracked is found, the monitoring person performs an operation of selecting the person frame of the person and specifying the person as the tracking target.

In the manner, when the monitoring person performs the operation of specifying the person to be tracked on the person search screen (Yes in ST 102), tracking target setter 24 sets the person specified by the monitoring person as the tracking target (ST 103). Next, camera searcher 25 searches for a current tracing camera 1 currently imaging the person to be tracked (ST 104). When the current tracing camera 1 is found (Yes in ST 105), camera predictor 26 predicts a successive camera 1 subsequently imaging the person to be tracked (ST 106).

Next, camera position presenter 27 and camera video presenter 28 performs processing for displaying, on monitor 7, the monitoring area map screen for displaying a monitoring area map indicating a position of each camera 1 on the map image indicating the monitoring area and the video list display screen for displaying a live video of each camera 1 as a list (ST 107). The monitoring area map screen and the video list display screen are displayed respectively in a separated manner on two monitors 7 at the same time. A window for displaying the monitoring area map and a window for displaying the video of each camera as the list may be displayed side by side on one monitor 7.

At the time, camera position presenter 27 highlights the position of the current tracing camera 1 on the monitoring area map on the monitoring area map screen. Camera video presenter 28 displays the video of each camera 1 and the frame image on the video display frame displaying the video of the current tracing camera 1 as the highlighted display on the video list display screen. Tracking target presenter 29 displays the person frame on the person detected from the video of each camera 1 on the video list display screen, and the person frame on the person to be tracked is displayed in a color different from other persons as the highlighted display.

Here, in the video list display screen, the monitoring person can select the number of cameras 1 for simultaneously displaying a video. In the exemplary embodiment, any one of nine or twenty-five cameras can be selected. In the video list display screen, when a predetermined operation is performed with respect to the video display frame displaying the video of each camera 1, a magnified video display screen for displaying the video of camera 1 in a magnified manner is displayed. With the video list display screen and the magnified video display screen, the monitoring person can check whether there is an error in the person to be tracked,

Here, when there is an error in a person displayed as the tracking target on the video list display screen and the magnified video display screen, that is, the person displayed with the person frame indicating the person to be tracked is different from the person specified as the tracking target, the monitoring person performs an operation of correcting the person to be tracked. Specifically, the monitoring person performs the operation of selecting the person frame of the correct person as the tracking target and specifying the person as the tracking target.

In the manner, when the monitoring person performs the operation of correcting the tracking target on the video list display screen and the magnified video display screen (Yes in ST 108), tracking target setter 24 performs processing for changing the person specified as the tracking target by the monitoring person to the tracking target (ST 109). With respect to the person who is changed to the tracking target, camera searcher 25 searches for the current tracing camera 1 (ST 104), camera predictor 26 predicts a successive camera 1 (ST 106), and the monitoring area map screen and the video list display screen are displayed on monitor 7 (ST 107).

On the other hand, when there is no error in the person displayed as the tracking target on the video list display screen and the magnified video display screen, while the monitoring person does not perform the operation of correcting the tracking target (No in ST 108), the person to be tracked moves to an imaging area of another camera 1, and the in-camera tracing processing on the person to be tracked ends (ST 110), camera searcher 25 searches for the current tracing camera 1 (ST 104). When the current tracing camera 1 is found (Yes in ST 105), camera predictor 26 predicts the successive camera 1 (ST 106), and the monitoring area map screen and the video list display screen are displayed on monitor 7 (ST 107).

The above processing is repeated until a current tracing camera 1 in camera searcher 25 is not found, that is, the person to be tracked moves to the outside of the monitoring area and the person to be tracked among persons detected from videos of cameras 1 is not found.

In the video list display screen and the magnified video display screen, in a case of losing sight of the person to be tracked, returning to person search screen, the monitoring person performs the operation of specifying the person to be tracked again based on the time and a position of camera 1 immediately before losing sight of the person to be tracked.

Hereinafter, each screen illustrated in FIG. 4 will be described in detail.

First, the person search screen illustrated in FIG. 4 will be described. FIGS. 6 and 7 are explanatory diagram illustrating the person search screen displayed on monitor 7. FIG. 6 illustrates the person search screen by the single camera and FIG. 7 illustrates the person search screen by the plurality of cameras.

In the person search screen, camera 1 currently imaging the person to be tracked and the imaging time of camera 1 are specified, the video in which the person to be tracked is imaged is found, and the person to be tracked is specified on the video. The person search screen is displayed first when the operation to start the tracking support processing is performed in PC 3. Specifically, camera 1 and the imaging time of camera 1 are specified based on the place and the time at which the person to be tracked, memorized by the monitoring person, is found.

The person search screen includes search time specifying unit 41, “time specification” button 42, “live” button 43, search camera specifying unit 44, a video display unit 45, and reproduction operator 46.

In search time specifying unit 41, the monitoring person specified the date and the time that is the center of a period assumed that the person to be tracked is imaged.

In search camera specifying unit 44, the monitoring person selects camera 1 according to a search mode (single-camera mode and multiple-camera mode). In the single-camera mode, a single camera 1 is specified, and a video in which the person to be tracked is imaged is found from the video of the single camera 1. In the multiple-camera mode, a plurality of cameras 1 is specified, and a video in which the person to be tracked is imaged is found from the videos of the plurality of cameras 1.

Search camera specifying unit 44 includes a search mode selector (the radio button) 47, pull-down menu selector 48, and “select from map” button 49.

In search mode selector 47, the monitoring person selects one search mode of the single-camera mode and the multiple-camera mode. When the single-camera mode is selected, the person search screen by the single camera illustrated in FIG. 6 is displayed. When the multiple-camera mode is selected, the person search screen by the plurality of cameras illustrated in FIG. 7 is displayed. In pull-down menu selector 48, the monitoring person selects the single camera 1 from a pull-down menu. When “select from map” button 49 is operated, the camera selection screen (refer to FIG. 8) is displayed, and the monitoring person can select the plurality of cameras 1 on the camera selection screen.

When camera 1 is selected in search camera specifying unit 44, further the time is specified in search time specifying unit 41, and “time specification” button 42 is operated, a time specification mode is set. In the mode, a video at the specified time of the specified camera 1 is displayed on the video display unit 45. On the other hand, when camera 1 is selected in search camera specifying unit 44 and “live” button 43 is operated, a live mode is set. In the mode, a current video of the specified camera 1 is displayed on the video display unit 45.

The switching of the search mode and camera 1 in search camera specifying unit 44 can be performed even in the middle of reproducing the video of camera 1 in the video display unit 45.

Video display unit 45 displays the video of camera 1, the name of camera 1, and the date and the time, that is, the imaging time of the video. In the person search screen by the single camera illustrated in FIG. 6, the video of the specified single camera 1 is displayed. In the person search screen by the plurality of cameras illustrated in FIG. 7, the videos of the plurality of the specified cameras 1 are displayed side by side in the video display unit 45.

In the video display unit 45, in the video of camera 1, blue person frame 51 is displayed on an image of the person detected by the in-camera tracing processing from the video. When an operation (click in a case of the mouse) of selecting person frame 51 using input device 6, such as the mouse, is performed, the person is set as the tracking target.

Reproduction operator 46 performs an operation on the reproduction of the video displayed on the video display unit 45. Reproduction operator 46 includes each button 52 of reproduction, reverse reproduction, stop, fast-forward, and rewind. Buttons 52 are operated to effectively view the video and effectively find the video in which the person to be tracked is imaged. Reproduction operator 46 can be operated in the time specification mode that the video of camera 1 is displayed by specifying the search time, and it is possible to reproduce videos up to the present centering on the time specified by search time specifying unit 41.

Reproduction operator 46 includes slider 53 for adjusting the display time of a video displayed on the video display unit 45, and it is possible to switch to a video at a predetermined time by operating the slider 53. Specifically, when an operation of shifting (drag) slider 53 using input device 6 such as the mouse is performed, a video at the time pointed by slider 53 is displayed on the video display unit 45. Slider 53 is included in a movable manner along bar 54, and the center of bar 54 is the time specified by search time specifying unit 41.

Reproduction operator 46 includes button 55 for specifying an adjustment range of the display time, and it is possible to specify the adjustment range of the display time, that is, a moving range of slider 53 defined by bar 54 by button 55. In the examples illustrated in FIGS. 6 and 7, it is possible to switch the adjustment range of the display time to one hour or six hours.

Next, the camera selection screen illustrated in FIG. 4 will be described. FIG. 8 is an explanatory diagram illustrating the camera selection screen displayed on monitor 7.

In the camera selection screen, the monitoring person selects a plurality of cameras 1 displaying videos on the person search screen (refer to FIG. 7) by the plurality of cameras. The camera selection screen is displayed by operating “select from map” button 49 in the person search screen.

The camera selection screen includes selected camera list display unit 61 and a camera selection unit 62.

In selected camera list display unit 61, a selected camera 1 is displayed as the list.

In the camera selection unit 62, a camera icon (video indicating camera 1) 65 for each of the plurality of cameras 1 is displayed in a superimposed manner on map image 64 indicating the layout of the inside of the store (state of the monitoring area). The camera icon 65 is displayed in an inclined manner so as to represent the imaging direction of camera 1. Thus, the monitoring person can roughly grasp an imaging area of camera 1.

When the camera icon 65 is selected in the camera selection unit 62, camera 1 corresponding to the selected camera icon 65 is added to selected camera list display unit 61. When camera 1 is selected in a checkbox 66, and a “delete” button 67 is operated, the selected camera 1 is deleted. When a “delete all” button 68 is operated, all the cameras 1 displayed in selected camera list display unit 61 are deleted. When a “determine” button 69 is operated, camera 1 displayed in selected camera list display unit 61 is determined as camera 1 to be displayed on the person search screen (refer to FIG. 7), a video of the determined camera 1 is displayed on the person search screen.

Setting information holder 31 (refer to FIG. 3) holds setting information on a coordinate and an orientation of the camera icon 65 and image information of the camera icon 65 corresponding to presence or absence of the selection. The camera icon 65 corresponding to presence or absence of the selection is, based on the pieces of information, displayed at a position and an orientation corresponding to the actual arrangement state of the cameras 1.

When the monitoring person selects one camera 1 for displaying the video on the person search screen (refer to FIG. 6) by the single camera, a screen similar to the camera selection unit 62 of the camera selection screen illustrated in FIG. 8 may be displayed so as to select the single camera 1 on the map image.

Next, the monitoring area map screen illustrated in FIG. 4 will be described. FIG. 9 is an explanatory diagram illustrating the monitoring area map screen displayed on monitor 7.

The monitoring area map screen presents a position of the current tracing camera 1, that is, camera 1 currently imaging the person to be tracked to the monitoring person. When the monitoring person performs the operation of specifying the person to be tracked in the person search screen (refer to FIGS. 6 and 7), the monitoring area map screen is displayed.

In the monitoring area map screen, similarly to the camera selection screen (refer to FIG. 8), a monitoring area map in which camera icon (video indicating camera 1) 62 for each of the plurality of cameras 1 is superimposed is displayed on map image 64 indicating the layout of the inside of the store (state of the monitoring area). The camera icon 65 of the current tracing camera 1 is highlighted among the camera icons 65. Specifically, for example, the camera icon 65 of the current tracing camera 1 is displayed with blinking.

When the person moves from an imaging area of the current tracing camera 1 to an imaging area of another camera 1, the highlighted display of the camera icon 65 of the current tracing camera 1 is updated corresponding to the switching of the current tracing camera 1. That is, the camera icon 65 to be highlighted is switched one after another corresponding to the movement of the person in the monitoring area.

The monitoring area map screen includes scroll bars 71 and 72. In a case where the entire monitoring area map is not fit on the screen, the scroll bars 71 and 72 slide a displaying position of the monitoring area map in the vertical direction and the horizontal direction. In the case where the entire monitoring area map is not fit on the screen, in an initial state where the monitoring area map screen is displayed on monitor 7, the displaying position of the monitoring area map is adjusted automatically such that the camera icon 65 of the current tracing camera 1 is positioned substantially at the center.

Next, the video list display screen illustrated in FIG. 4 will be described. FIGS. 10 and 11 are explanatory diagrams illustrating the video list display screen displayed on monitor 7. FIG. 10 illustrates a video list display screen when the number of displayed cameras is nine cameras, and FIG. 11 illustrates a video list display screen when the number of displayed cameras is twenty-five cameras.

In order to monitor the action of a person specified as the tracking target on the person search screen (refer to FIGS. 6 and 7), the video list display screen is a monitoring screen for displaying live videos of a current tracing camera 1 currently imaging the person to be tracked, a successive camera 1 subsequently imaging the person to be tracked, and a predetermined number of cameras 1 around the current tracing camera 1. When the monitoring person performs the operation of specifying the person to be tracked in the person search screen, the video list display screen is displayed.

The video list display screen includes a number of displayed cameras selector 81, person frame display selector 82, video list display unit 83, and reproduction operator 46.

In the number of displayed camera selector 81, the monitoring person selects the number of displayed cameras, that is, the number of cameras 1 for simultaneously displaying a video in video list display unit 83. In the exemplary embodiment, any one of nine or twenty-five cameras can be selected. When nine cameras are selected in the number of displayed camera selector 81, the video list display screen illustrated in FIG. 10 is displayed, and when twenty-five cameras are selected, the video list display screen illustrated in FIG. 11 is displayed.

In person frame display selector 82, the monitoring person selects a person frame display mode. In the exemplary embodiment, on a video of each camera 1 displayed on video display frame 85, person frame 51 is displayed on a person detected from the video. It is possible to select any one of a first person frame display mode for displaying person frame 51 on all persons detected from the video of each camera 1 or a second person frame display mode for displaying person frame 51 only on the person to be tracked. In the second person frame display mode, person frame 51 of a person other than the person to be searched is not displayed.

In video list display unit 83, a plurality of video display frame 85 respectively displaying the video of each camera 1 is arranged side by side in the vertical and horizontal directions. In the initial state of the video list display screen, a live video (current video) of each camera 1 is displayed. When the display time of the video is adjusted by reproduction operator 46, the past video of each camera 1 is displayed.

In video list display unit 83, the video of the current tracing camera 1, that is, the video of camera 1 currently imaging the person to be searched is displayed at the center of video display frame 85, and the videos of cameras 1 other than the current tracing camera 1 are displayed around video display frame 85.

In video list display unit 83, the highlighted display is performed to identify each video display frame 85 of the current tracing camera 1 and a successive camera 1 from the video display frames 85 of other cameras 1. In the exemplary embodiment, frame image 87 subjected to predetermined coloring is displayed at the peripheral portion of video display frame 85 as the highlighted display. Further, in order to identify each video display frame 85 of the current tracing camera 1 and the successive camera 1, coloring different from video display frame 85 is subjected to the frame image 87. For example, yellow frame image 87 is displayed on video display frame 85 of the current tracing camera 1, and green frame image 87 is displayed on video display frame 85 of the successive camera.

When the person moves from an imaging area of the current tracing camera 1 to an imaging area of another camera 1, the video of each camera 1 displayed on each video display frame 85 of video list display unit 83 is updated corresponding to the switching of the current tracing camera 1. At the time, since the current tracing camera 1 as the reference is switched, the videos of the video display frames 85 at the peripheral portion are replaced with videos of other cameras 1 in addition to the video of video list display unit 83 at the center, and video list display unit 83 largely changes as a whole.

Here, in the exemplary embodiment, in camera video presenter 28 (refer to FIG. 3), in a case where the total number of cameras 1 installed at the monitoring area exceeds the number of displayed cameras, that is, the number of the video display frames 85 in video list display unit 83, cameras 1 having the high degree of relevance with the current tracing camera 1 are selected by the number of displayed cameras selected in the number of displayed cameras selector 81, and videos of the selected cameras 1 are displayed on the screen of video list display unit 83. In a case where the total number of cameras 1 is smaller than the number of displayed cameras, the extra video display frame 85 is displayed in a gray-out state.

In the video display frames 85 of the cameras 1 other than the current tracing camera 1, camera 1 for displaying video on each video display frame 85 is selected based on the high degree of relevance with the current tracing camera 1. That is, the video display frames 85 of the cameras 1 having the high degree of relevance with the current tracing camera 1 are arranged near video display frame 85 at the center, and the video display frames 85 of the cameras 1 having low degree of relevance with the current tracing camera 1 are arranged at positions away from video display frame 85 at the center.

In the video display frames 85 of the cameras 1 other than the current tracing camera 1, camera 1 for displaying video on each video display frame 85 is selected so as to substantially correspond to the actual positional relationship with the current tracing camera 1. That is, the video display frames 85 of other cameras 1 are arranged at the position in the upward, downward, rightward, leftward and inclined directions with respect to video display frame 85 of the current tracing camera 1 so as to substantially correspond to the direction in which other cameras 1 are installed based on the current tracing camera 1.

The video of the current tracing camera 1 is displayed always on video display frame 85 at the center, that is, yellow frame image 87 is displayed always on video display frame 85 at the center, but video display frame 85 displaying the video of the successive camera 1, that is, video display frame 85 displaying green frame image 87 is changed at any time.

In camera 1 installed near the end of the monitoring area, since there is no adjacent camera 1 in the direction of the end side of the monitoring area, when camera 1 installed near the end of the monitoring area is selected as the current tracing camera 1, extra video display frames 85 positioned in the direction in which another camera 1 does not exist with respect to the current tracing camera 1 are displayed in the gray out state.

When a person moves from an imaging area of the current tracing camera 1 to another imaging area of the successive camera 1, there is a case where in-camera tracing by the video of the successive camera 1 starts before the in-camera tracing by the video of the current tracing camera 1 ends. In the case, at the timing when the in-camera tracing by the video of the current tracing camera 1 ends, the successive camera 1 is switched to the current tracing camera 1, and the video of the successive camera 1 is displayed on video display frame 85 at the center.

When a person moves from an imaging area of the current tracing camera 1 to another imaging area of the successive camera 1, there is a case where the time lag occurs between the end of the in-camera tracing by the video of the current tracing camera 1 and the start of the in-camera tracing by the video of the successive camera 1. In the case, even when the in-camera tracing by the video of the current tracing camera 1 ends, video display frame 85 displaying the video of each camera 1 is not changed during a period before the in-camera tracing by the video of the successive camera 1 starts.

In video list display unit 83, on the video of each camera 1 displayed on video display frame 85, person frame 51 is displayed on a person detected by the in-camera tracing processing from the video. In particular, in a case where person frame 51 is displayed on all persons detected from the video of each camera 1, person frame 51 of the person to be tracked is subjected to highlighting by identifiable coloring from person frame 51 displayed on other persons. For example, person frame 51 of the person to be searched is displayed in red, and person frame 51 of the person other than the person to be searched is displayed in blue.

Here, red person frame 51 displaying the person to be searched is displayed only on the person to be searched appearing in the video of the current tracing camera 1, becomes one in entire video list display unit 83, and the person frames 51 of other persons are all blue. That is, in the video of camera 1 other than the current tracing camera 1, particularly, even though the tracing of the person to be searched is started in the video of the successive camera 1, the blue person frame is displayed on the person. Person frame 51 of the person to be searched appearing in the video of the successive camera 1 is changed to red after the successive camera 1 is changed to the current tracing camera 1, and the video is displayed on video display frame 85 at the center.

In video list display unit 83, the imaging date and time of the video displayed on each video display frame 85 are displayed, but the name of camera 1 may be displayed on each video display frame 85.

Reproduction operator 46 is similar to the person search screen (refer to FIGS. 6 and 7), but in the video list display screen, a video from the time specified in the person search screen to the current time can be displayed as the moving image. That is, the moving range of slider 53 for adjusting the display time of the video, that is, the starting point (left end) of bar 54 for defining the adjustment range of the display time is the time specified in the person search screen, and the end point (right end) of bar 54 is the current time.

In the manner, by adjusting the display time of the video displayed on video display unit 45 by reproduction operator 46, the monitoring person can check the video in the past. By starting the reproduction of the video from the appropriate time, the video of each camera 1 imaging the person to be tracked is displayed subsequently while changing camera 1 with the lapse of time on video display frame 85 of the current tracing camera 1 at the center of video list display unit 83.

In the video list display screen, in a case where there is an error in the person to be tracked, that is, the person displayed with red person frame 51 indicating the person to be tracked is different from the person specified as the tracking target, the monitoring person can perform an operation of correcting the person to be tracked. Specifically, when the correct person as the tracking target is found among the persons displayed with blue person frame 51 indicating that it is not the person to be tracked, person frame 51 of the person is selected, and the person is specified as the tracking target.

Here, in a case where another person appearing in the video of the current tracing camera 1 displayed on video display frame 85 at the center is selected, person frame 51 of the selected person is changed only from blue to red, and there is no significant change in video list display unit 83. However, in a case where the person appearing in the video of camera 1 other than the current tracing camera 1 displayed on video display frame 85 at the peripheral portion is selected, since the current tracing camera 1 is changed, there is a significant change in video list display unit 83.

Next, the magnified video display screen illustrated in FIG. 4 will be described. FIG. 12 is an explanatory diagram illustrating the magnified video display screen displayed on monitor 7.

The magnified video display screen displays the video of each camera 1 displayed in a magnified manner in video display frame 85 of the video list display screen and is displayed when magnification icon 88 in video display frame 85 of the video list display screen is operated. In the example illustrated in FIG. 12, the video magnified display screen is displayed as a pop-up on the video list display screen.

In the magnified video display screen, red person frame 51 is displayed on the person to be tracked among the persons detected from the video, and blue person frame 51 is displayed on the person other than the person to be tracked. Reproduction button 91 is displayed at the center of the magnified video display screen. When the button 91 is operated, similarly to the video list display screen, the video from the time specified in the person search screen to the current time can be displayed as the moving image.

In the magnified video display screen, the magnified video may be reproduced in conjunction with the video of each video display frame 85 of the video list display screen, that is, the magnified video of the magnified video display screen and the video of the video list display screen may be displayed at the same time. In the case, even when video display frame 85 selected in the video list display screen is changed to the video of another camera 1 by the switching of the current tracing camera 1 to another camera 1, the video of the original camera 1 may be displayed continuously in the magnified video display screen. When camera 1 of video display frame 85 selected in the video list display screen is excluded from a display target of the video list display screen, the magnified video display screen may be ended.

In the magnified video display screen, in the case where there is an error in the person to be tracked, that is, the person displayed with red person frame 51 indicating the person to be tracked is different from the person specified as the tracking target, when the person to be tracked is found among the persons displayed with blue person frame 51 indicating that it is not the person to be tracked, blue person frame 51 of the person is selected, and the person can be changed to the tracking target.

As described above, in the exemplary embodiment, tracking target setter 24 displays the video of camera 1 on monitor 7, and sets the person to be tracked in response to the input operation of the monitoring person for specifying the person to be tracked on the video. Camera searcher 25 searches for the current tracing camera 1 currently imaging the person to be tracked based on the tracing information acquired by the tracing processing with respect to the video of camera 1. Camera predictor 26 predicts the successive camera 1 subsequently imaging the person to be tracked based on the tracing information. Camera position presenter 27 displays the monitoring area map indicating the position of the current tracing camera 1 on monitor 7. Camera video presenter 28 displays the live video of each of the plurality of cameras 1 on monitor 7, and highlights each live video of the current tracing camera 1 and the successive camera 1 in an identifiable manner from the live videos of other cameras 1. In particular, camera position presenter 27 and camera video presenter 28 display the monitoring area map and the live video of camera 1 in different display windows on monitor 7, and update the position of the current tracing camera 1 on the monitoring area map and each highlighted live video of the current tracing camera 1 and the successive camera 1 corresponding to the switching of the current tracing camera 1.

Consequently, since the video of the current tracing camera in which the person to be tracked is imaged and the video of the successive camera predicted that the person to be tracked is imaged subsequently are highlighted, and the monitoring area map and the video of the camera are displayed in different display windows on the display apparatus, it is possible to greatly reduce the burden of the monitoring person performing the tracking work without being limited by the number of the cameras and the arrangement state of the cameras and to continue tracking without losing sight of the person to be tracked.

In the exemplary embodiment, tracking target setter 24 sets the person to be tracked on the video displayed in response to the input operation of specifying the time and camera 1 by the monitoring person in the person search screen. Consequently, it is possible to find the video in which the person to be tracked is imaged from the person search screen based on the place and the time at which the person to be tracked, memorized by the monitoring person, is found.

In the exemplary embodiment, tracking target presenter 29 displays the mark representing the person detected from the video of camera 1 on the live video of camera 1 based on the tracing information and highlights the mark of the person to be tracked in an identifiable manner from the marks of other persons. In tracking target setter 24, in the case where there is an error in the highlighted mark that is, the highlighted mark is displayed on the person different from the person to be tracked, the monitoring person selects the mark of the correct person to be tracked among the videos of all the cameras 1 and changes the selected person to the tracking target. Consequently, in the case where there is the error in the person presented as the tracking target by tracking target presenter 29, by changing the person to be tracked, the person to be tracked is imaged certainly in the video of the current tracing camera thereafter, and it is possible to continue tracking without losing sight of the person to be tracked.

In the exemplary embodiment, setting information holder 31 holds the information on the degree of relevance representing the level of relevance between two cameras 1. Camera video presenter 28 arranges the videos of other cameras 1 according to the degree of relevance between the current tracing camera 1 and other cameras 1 based on the video of the current tracing camera 1 on the screen of monitor 7 displaying video of each of the plurality of cameras 1. Consequently, since the videos of the cameras 1 other than the current tracing camera 1 are arranged according to the degree of relevance based on the video of the current tracing camera 1, even in a case of losing sight of the person to be tracked in the video of the current tracing camera 1, it is possible to easily find the video of camera 1 in which the person to be tracked is imaged.

In the exemplary embodiment, in camera video presenter 28, it is possible to increase or decrease the number of cameras for simultaneously displaying videos on the screen of monitor 7 corresponding to the number of cameras 1 having the high degree of relevance with the current tracing camera 1. Consequently, since it is possible to increase or decrease the number of cameras for simultaneously displaying videos on the screen of monitor 7 (the number of displayed cameras), it is possible to display the videos of the cameras 1 by the necessary number of cameras. In the case, the monitoring person may manually select the number of displayed cameras as necessary, or the number of displayed cameras may be switched automatically based on the number of cameras 1 having the high degree of relevance with the current tracing camera 1 in camera video presenter 28.

In the exemplary embodiment, in camera video presentation unit, in a case where the total number of cameras 1 installed at the monitoring area exceeds the number of cameras 1 for simultaneously displaying the videos on the screen of monitor 7, cameras 1 having the high degree of relevance with the current tracing camera 1 are selected by the number of the cameras 1 to be displayed simultaneously, and the videos of the cameras 1 are displayed on the screen of monitor 7. Consequently, since the person to be tracked suddenly does not move from the imaging area of the current tracing camera to the camera having the low degree of relevance with the current tracing camera, that is, the imaging area of the camera far away from the current tracing camera, it is possible to continue tracking without losing sight of the person to be tracked by displaying only videos of cameras having the high degree of relevance with the current tracing camera.

In the exemplary embodiment, camera video presenter 28 displays the videos of the cameras 1 on the screen of monitor 7 side by side in the vertical and horizontal directions, and arranges the videos of other cameras 1 with the video of the current tracing camera 1 as the center around the video of the current tracing camera 1 corresponding to the actual positional relationship with the current tracing camera 1. Consequently, since the video of the current tracing camera 1 is arranged at the center, the monitoring person can easily check the person to be tracked. Since the video of camera 1 other than the current tracing camera 1 is arranged around the video of the current tracing camera 1 in correspondence with the actual positional relationship of camera 1, even in a case of losing sight of the person to be tracked in the video of the current tracing camera 1, it is possible to easily find the video of camera 1 in which the person to be tracked is imaged.

In the exemplary embodiment, in response to the input operation of the monitoring person for selecting any one of the live videos for each camera 1 displayed on monitor 7, camera video presenter 28 displays the live video of camera 1 in a magnified manner on monitor 7. Consequently, since the video of camera 1 is displayed in a magnified manner, it is possible to observe the situation of the person to be tracked in detail.

### Second Exemplary Embodiment

Next, a second exemplary embodiment will be described. The points not mentioned in particular here are the same as those in the above exemplary embodiment.

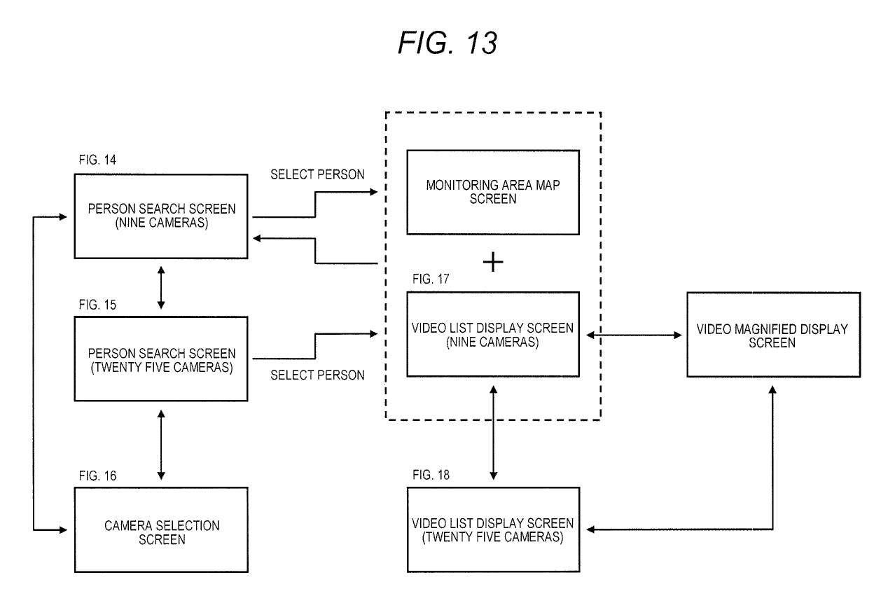

First, each screen displayed on monitor 7 in the second exemplary embodiment will be described. FIG. 13 is an explanatory diagram illustrating a transition state of the screens displayed on monitor 7 according to the second embodiment.

In the first exemplary embodiment, the person search screen having the screen configuration dedicated to the person search is used separately from the video list display screen displaying the live video. However, in the second exemplary embodiment, a person search screen and a video list display screen have the same screen configuration, and it is possible to select the number of displayed cameras (nine or twenty-five cameras) on the person search screen, similarly to the video list display screen. In the second exemplary embodiment, in a camera selection screen, a monitoring person selects a camera displaying a video on a video display frame at the center on the video list display screen.

In the second exemplary embodiment, similarly to the first exemplary embodiment, a monitoring area map screen is displayed with the video list display screen at the same time, and the monitoring area map screen is the same as the monitoring area map screen of the first exemplary embodiment (refer to FIG. 9). When a magnification icon is operated in the video list display screen, a magnified video display screen is displayed, and the magnified video display screen is the same as the magnified video display screen of the first exemplary embodiment (refer to FIG. 12).

In the second exemplary embodiment, similarly to the first exemplary embodiment, in the video list display screen and the magnified video display screen, in a case of losing sight of a person specified as a tracking target, returning to the person search screen, an operation of specifying the person to be tracked is performed again based on a time and a position of camera 1 immediately before losing sight of the person to be tracked.

Hereinafter, each screen illustrated in FIG. 13 will be described in detail.

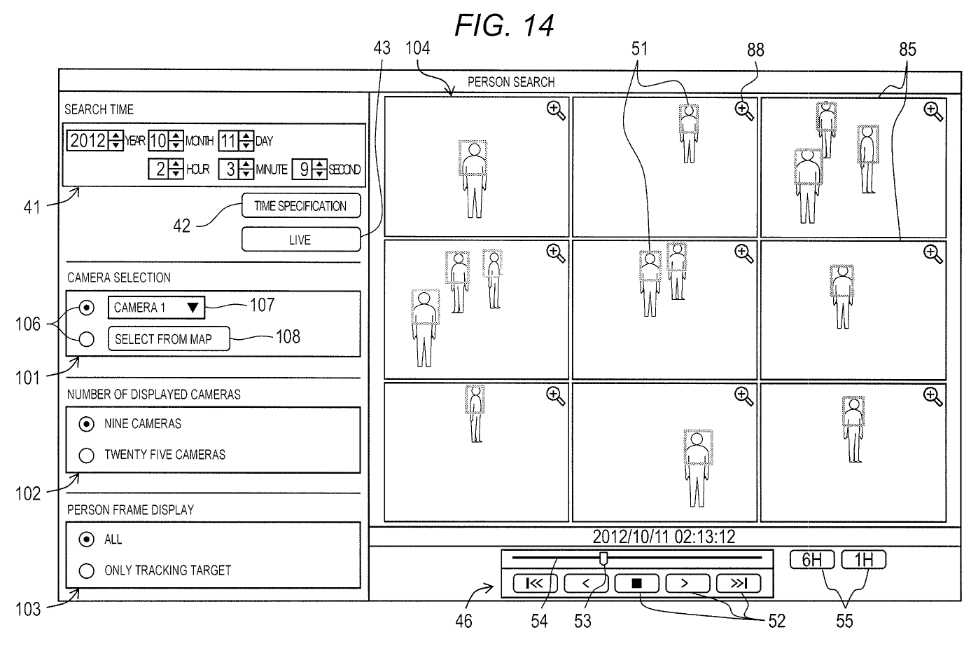

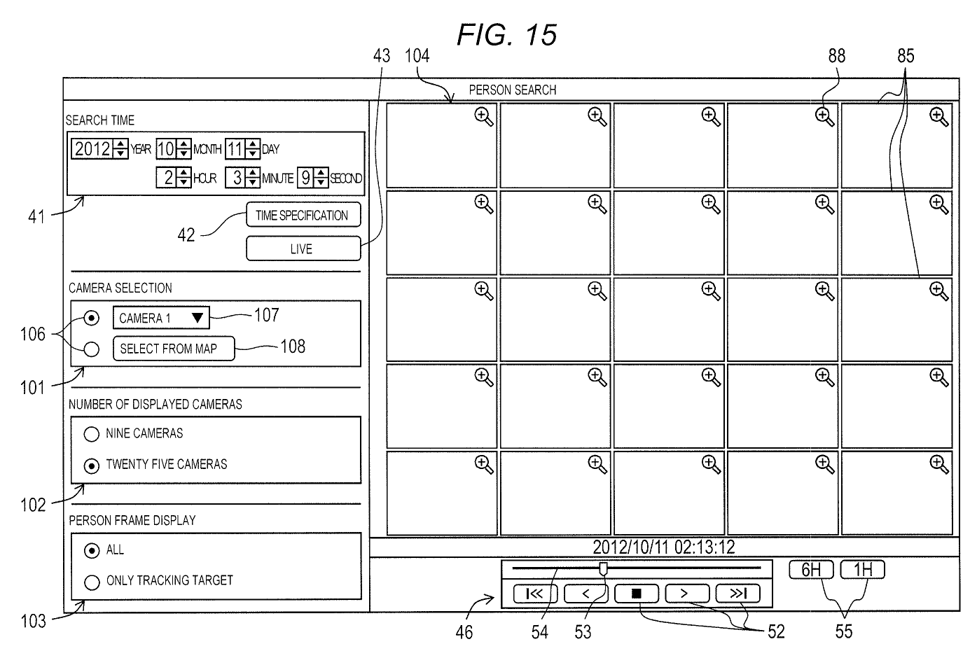

First, the person search screen illustrated in FIG. 13 will be described. FIGS. 14 and 15 are explanatory diagrams illustrating the person search screen displayed on monitor 7. FIG. 14 illustrates a person search screen when the number of displayed cameras is nine cameras, and FIG. 15 illustrates a person search screen when the number of displayed cameras is twenty-five cameras.

The person search screen includes search time specifying unit 41, “time specification” button 42, “live” button 43, camera selector 101, a number of displayed cameras selector 102, person frame display selector 103, video list display unit 104, and reproduction operator 46. Search time specifying unit 41, “time specification” button 42, “live” button 43, and reproduction operator 46 are the same as the person search screen of the first exemplary embodiment (refer to FIGS. 6 and 7).

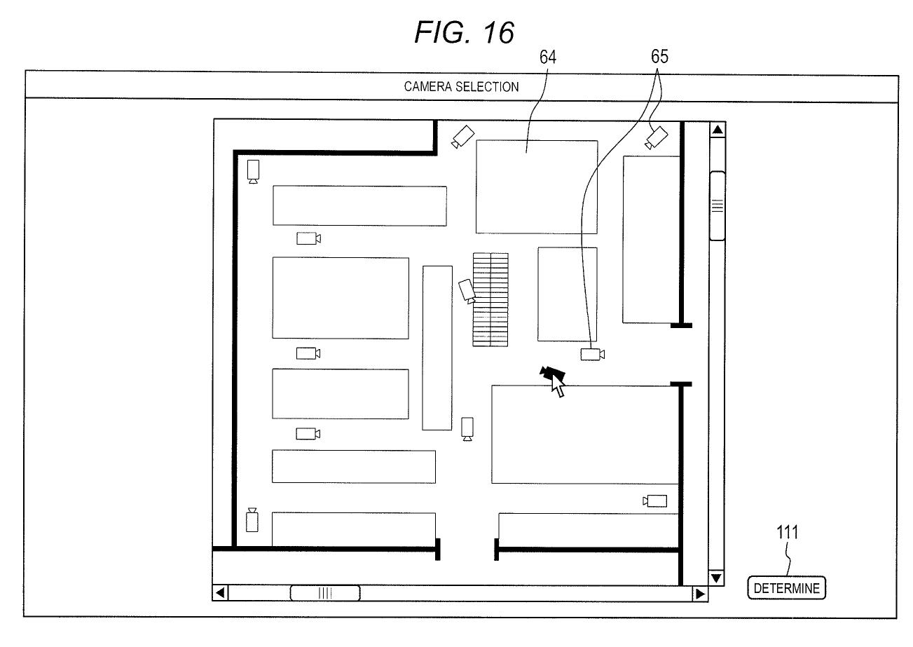

In camera selector 101, the monitoring person selects camera 1 displaying the video in video display frame 85 at the center of video list display unit 104. Camera selector 101 includes mode selector (radio button) 106, pull-down menu operator 107, and “select from map” button 108. In the mode selector 106, the monitoring person selects any one of a mode of selecting camera 1 in the pull-down menu or a mode of selecting camera 1 on the map. In pull-down menu operator 107, camera 1 can be selected using the pull-down menu. When “select from map” button 108 is operated, the camera selection screen (refer to FIG. 16) is displayed, it is possible to select camera 1 in the camera selection screen.

In the number of displayed camera selector 102, the monitoring person selects the number of displayed cameras, that is, the number of cameras 1 for simultaneously displaying in video list display unit 104. In the exemplary embodiment, it is possible to select any one of nine or twenty-five cameras. When nine cameras are selected in the number of displayed camera selector 102, the person search screen illustrated in FIG. 14 is displayed, and when twenty-five cameras are selected, the person search screen illustrated in FIG. 15 is displayed.

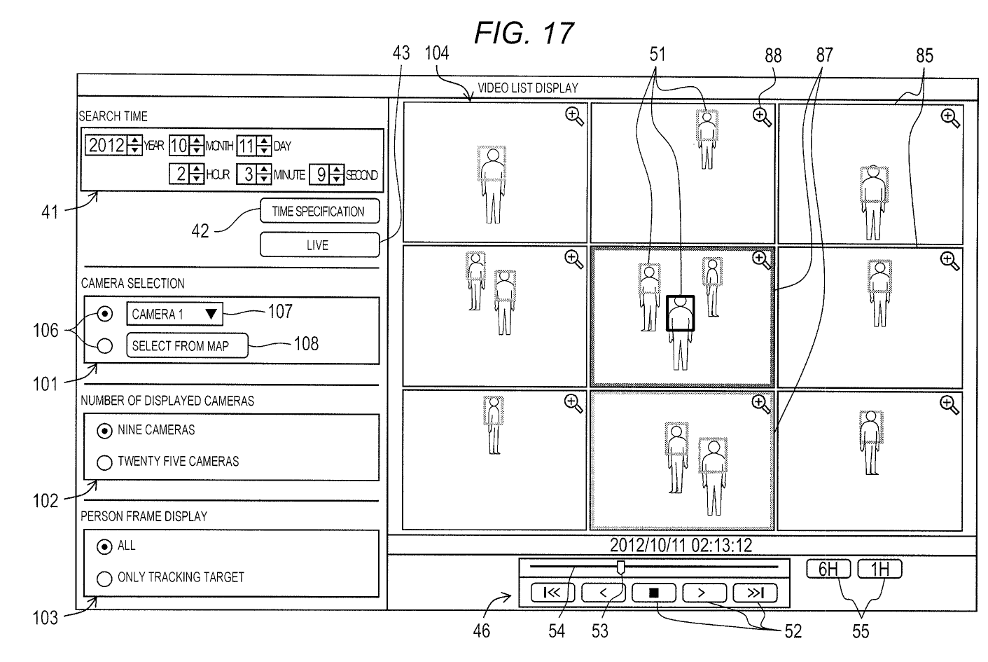

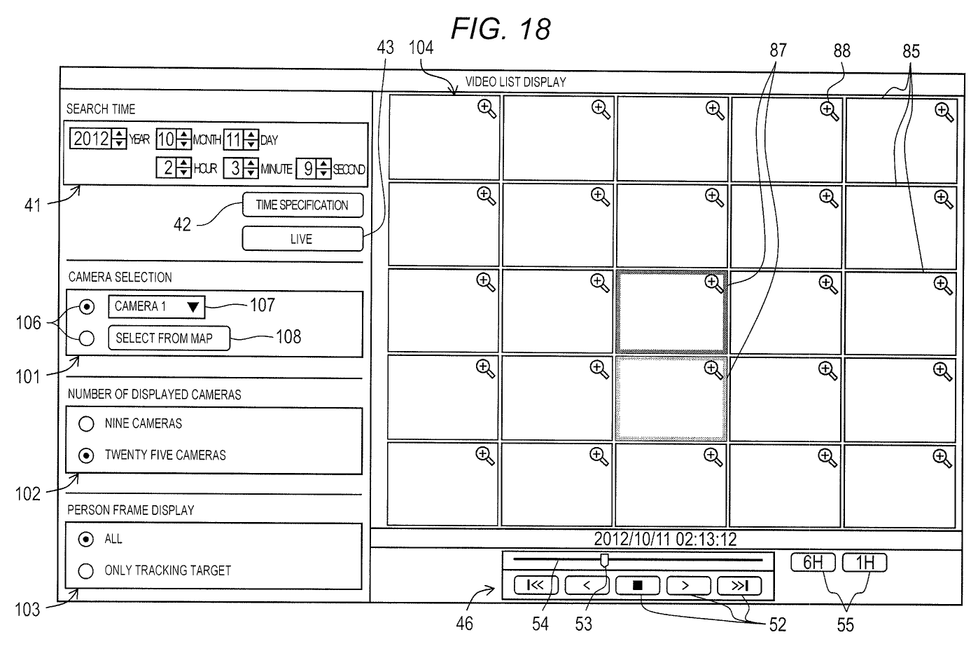

In person frame display selector 103, it is possible to select any one of a first person frame display mode displaying a person frame on all persons detected from the video of each camera 1 and a second person frame display mode displaying the person frame only on the person to be tracked. The selection is effective in the video list display screen (refer to FIGS. 17 and 18), and the person frame is displayed on all persons detected from video of each camera 1 in the person search screen.

In video list display unit 104, a plurality of video display frames 85 respectively displaying the video of each camera 1 is arranged side by side in the vertical and horizontal directions. In video list display unit 104, on the video of each camera 1 displayed on video display frame 85, blue person frame 51 is displayed on the person detected by an in-camera tracing processing from the video, and person frame 51 is selected to set the person as the tracking target.

A camera selection screen illustrated in FIG. 13 will be described. FIG. 16 is an explanatory diagram illustrating the camera selection screen displayed on monitor 7.

The camera selection screen selects one camera 1 displaying the video on video display frame 85 at the center in the person search screen (refer to FIGS. 14 and 15), and camera icon (video indicating camera 1) 62 of each of the plurality of cameras 1 is displayed in a superimposed manner on map image 64 indicating the layout of the inside of the store (state of the monitoring area).

When the camera icon 65 is selected in the camera selection screen, the camera icon 65 is changed to a selected state, then a determination button 111 is operated, camera 1 displaying the video on video display frame 85 at the center of the person search screen (refer to FIGS. 14 and 15) is determined. In camera video presenter 28 (refer to FIG. 3), cameras 1 having the high degree of relevance with camera 1 selected in the camera selection screen are selected by the number of displayed cameras selected in the person search screen, and videos of the selected cameras 1 are displayed on the person search screen.

Next, the video list display screen illustrated in FIG. 13 will be described. FIGS. 17 and 18 are explanatory diagrams illustrating the video list display screen displayed on monitor 7. FIG. 17 illustrates a video list display screen when the number of displayed cameras is nine cameras, and FIG. 18 illustrates a video list display screen when the number of displayed cameras is twenty-five cameras.

The video list display screen is substantially the same as the video list display screen (refer to FIGS. 10 and 11) of the first exemplary embodiment. When nine cameras are selected in the number of displayed camera selector 102, the video list display screen illustrated in FIG. 17 is displayed, when twenty-five cameras are selected, the video list display screen illustrated in FIG. 18 is displayed. In the video list display screen, yellow frame image 87 is displayed on video display frame 85 of the current tracing camera 1, green frame image 87 is displayed on video display frame 85 of the successive camera 1, red person frame 51 is displayed on the person to be searched, and blue person frame 51 is displayed on the person other than the person to be searched.

The present disclosure is described based on the specific exemplary embodiments, but the exemplary embodiments are merely examples, and the present disclosure is not limited by the exemplary embodiments. Each configuration element of the tracking support apparatus, the tracking support system, and the tracking support method according to the present disclosure illustrated in the exemplary embodiments described above is are not necessarily essential, and it is possible to select as necessary as long as without departing from the scope of the present disclosure.

For example, in the exemplary embodiments described above, the example of a retail store such as the supermarket is described, but it is possible to employ in a store of business type other than the retail store, for example, a restaurant such as a casual dining restaurant, further, in a facility other than the store such as an office.

In the exemplary embodiments described above, the example of tracking a person as the moving object is described, but it is possible to employ a configuration of tracking a moving object other than a person, for example, a vehicle such as a car or a bicycle.

In the exemplary embodiments described above, a monitoring person selects manually the number of cameras 1 for simultaneously displaying the videos (the number of displayed cameras) in the video list display screen, that is, the number of video display frame 85 respectively displaying the video of each camera 1, but the number of displayed cameras may be switched automatically based on the number of cameras 1 having the high degree of relevance with the current tracing camera 1 in camera video presenter 28.

In the exemplary embodiments described above, as illustrated in FIGS. 1 and 3, the examples in which in-camera tracing processing apparatus 4 performs the in-camera tracing processing, and PC 3 performs the inter-camera tracing processing and the tracking support processing are described, but a configuration in which the in-camera tracing processing is performed by PC 3 may be employed. It is also possible to employ a configuration in which the in-camera tracing processing unit is included in camera 1. It is also possible to configure all or a part of inter-camera tracing processor 22 with a tracing processing apparatus different from PC 3.

In the exemplary embodiments described above, as illustrated in FIG. 2, camera 1 is a box type camera that the viewing angle is limited. However, the camera is not limited to the type, and it is possible to use an omnidirectional camera capable of imaging a wide range.

In the exemplary embodiments described above, the processing necessary for the tracking support is performed by the apparatus installed at the store. However, the necessary processing may be performed by, as illustrated in FIG. 1, PC 11 installed at the head office or cloud computer 12 configuring a cloud computing system. The necessary processing is shared among a plurality of information processing apparatuses, and information may be delivered to the plurality of information processing apparatuses through a communication medium such as an IP network or LAN, or a storage medium such as a hard disk or a memory card. In the case, the tracking support system is configured with the plurality of information processing apparatuses sharing the necessary processing.

In the system configuration including cloud computer 12, necessary information can be displayed on smartphone 13 connected to cloud computer 12 with a network or a portable terminal such as a tablet terminal in addition to PCs 3 and 11 installed at the store and the head office. Consequently, it is possible to check the necessary information at an arbitrary place, for example, at a remote place in addition to the store and the head office.

In the exemplary embodiments described above, recorder 2 accumulating the video of camera 1 is installed at the store. However, in a case where the necessary processing for the tracking support is performed by PC 11 installed at the head office or cloud computer 12, the video of camera 1 is sent to, for example, the head office or an operating facility of the cloud computing system and may be accumulated in an apparatus installed at the place.

### INDUSTRIAL APPLICABILITY

The tracking support apparatus, the tracking support system, and the tracking support method according to the present disclosure have an effect that the work burden of the monitoring person who is tracking the person while watching the video of each camera can be reduced without being limited by the number of the cameras and the arrangement state of the cameras, and the monitoring person can continue tracking without losing sight of the person to be tracked. It is useful as the tracking support apparatus, the tracking support system, the tracking support method, and the like for supporting the work of the monitoring person tracking the moving object to be tracked by displaying the live video of each of the plurality of cameras imaging the monitoring area on the display apparatus.

### REFERENCE MARKS IN THE DRAWINGS

1 CAMERA

2 RECORDER (VIDEO STORAGE)

3 PC (TRACKING SUPPORT APPARATUS)

4 IN-CAMERA TRACING PROCESSING APPARATUS

6 INPUT DEVICE

7 MONITOR (DISPLAY APPARATUS)

11 PC

12 CLOUD COMPUTER

13 SMARTPHONE

21 TRACING INFORMATION STORAGE

22 INTER-CAMERA TRACING PROCESSOR

23 INPUT INFORMATION ACQUIRER

24 TRACKING TARGET SETTER

25 CAMERA SEARCHER

26 CAMERA PREDICTOR

27 CAMERA POSITION PRESENTER

28 CAMERA VIDEO PRESENTER

29 TRACKING TARGET PRESENTER

30 SCREEN GENERATOR

31 SETTING INFORMATION HOLDER

1. A tracking support apparatus that supports a work of a monitoring person tracking a moving object to be tracked by displaying a live video of each of a plurality of cameras imaging a monitoring area on a display apparatus, the apparatus comprising:
a tracking target setter that sets the moving object to be tracked in response to an input operation of the monitoring person for displaying the video of the camera on the display apparatus and for specifying the moving object to be tracked on the videos;
a camera searcher that searches for a current tracing camera currently imaging the moving object to be tracked based on tracing information acquired by tracing processing with respect to the video of the camera;
a camera predictor that predicts a successive camera subsequently imaging the moving object to be tracked based on the tracing information;
a camera position presenter that displays a monitoring area map indicating a position of the current tracing camera on the display apparatus; and
a camera video presenter that displays the live video of each of the plurality of cameras on the display apparatus and highlights each live video of the current tracing camera and the successive camera in an identifiable manner different from live videos of other cameras,
wherein the camera position presenter and the camera video presenter display the monitoring area map and the live video of the camera in different display windows on the display apparatus and update the position of the current tracing camera on the monitoring area map and each highlighted live video of the current tracing camera and the successive camera corresponding to switching of the current tracing camera.

2. The tracking support apparatus according to claim 1,
wherein the tracking target setter sets a moving object to be tracked on a video displayed in response to an input operation for specifying a time and a camera by a monitoring person in a person search screen.

3. The tracking support apparatus according to claim 1, further comprising:
a tracking target presenter that displays a mark representing the moving object detected from the video of the camera on the live video of the camera based on the tracing information and highlights the mark of the person to be tracked in an identifiable manner different from the marks of other persons,
wherein, in a case where there is an error in the highlighted mark, the tracking target setter causes a monitoring person to select the mark of the correct moving object as the tracking target among the videos of all the cameras so as to change the moving object selected by the monitoring person to the tracking target.

4. The tracking support apparatus according to claim 1, further comprising:
a setting information holder that holds information on a degree of relevance representing a level of relevance between the two cameras,
wherein the camera video presenter arranges the videos of other cameras according to the degree of relevance between the current tracing camera and other cameras based on the video of the current tracing camera on the screen of the display apparatus displaying video of each of the plurality of the cameras.

5. The tracking support apparatus according to claim 4,
wherein the camera video presenter can increase or decrease the number of the cameras for simultaneously displaying videos on the screen of the display apparatus corresponding to the number of the cameras having a high degree of relevance with the current tracing camera.

6. The tracking support apparatus according to claim 4,
wherein, in a case where a total number of the cameras installed at the monitoring area exceeds the number of cameras for simultaneously displaying videos on the screen of the display apparatus, the camera video presenter selects the cameras having the high degree of relevance with the current tracing camera by the number of cameras, and displays the videos of the cameras on the screen of the display apparatus.

7. The tracking support apparatus according to claim 4,
wherein the camera video presenter displays the videos of the cameras on the screen of the display apparatus side by side in vertical and horizontal directions and arranges the videos of other cameras with the video of the current tracing camera as a center around the video of the current tracing camera corresponding to an actual positional relationship between the cameras.

8. The tracking support apparatus according to claim 1,
wherein, in response to an input operation of a monitoring person for selecting any one of the live videos for each camera displayed on the display apparatus, the camera video presenter displays the live video of the camera in a magnified manner on the display apparatus.

9. A tracking support system that supports a work of a monitoring person tracking a moving object to be tracked by displaying a live video of each of a plurality of cameras imaging a monitoring area on a display apparatus, the system comprising:
the camera for imaging the monitoring area;
the display apparatus for displaying a video of each camera; and
a plurality of information processing apparatuses,
wherein any one of the plurality of information processing apparatuses includes
a tracking target setter that sets the moving object to be tracked in response to an input operation of the monitoring person for displaying the video of the camera on the display apparatus and for specifying the moving object to be tracked on the videos;
a camera searcher that searches for a current tracing camera currently imaging the moving object to be tracked based on tracing information acquired by tracing processing with respect to the video of the camera;
a camera predictor that predicts a successive camera subsequently imaging the moving object to be tracked based on the tracing information;
a camera position presenter that displays a monitoring area map indicating a position of the current tracing camera on the display apparatus; and
a camera video presenter that displays the live video of each of the plurality of cameras on the display apparatus and highlights each live video of the current tracing camera and the successive camera in an identifiable manner different from live videos of other cameras,
wherein the camera position presenter and the camera video presenter display the monitoring area map and the live video of the camera in different display windows on the display apparatus and update the position of the current tracing camera on the monitoring area map and each highlighted live video of the current tracing camera and the successive camera corresponding to switching of the current tracing camera.

10. A tracking support method that causes an information processing apparatus to perform processing for supporting a work of a monitoring person tracking a moving object to be tracked by displaying a live video of each of a plurality of cameras imaging a monitoring area on a display apparatus, the method comprising steps of:
setting the moving object to be tracked in response to an input operation of the monitoring person for displaying the video of the camera on the display apparatus and for specifying the moving object to be tracked on the videos;
searching for a current tracing camera currently imaging the moving object to be tracked based on tracing information acquired by tracing processing with respect to the video of the camera;
predicting a successive camera subsequently imaging the moving object to be tracked based on the tracing information;
displaying a monitoring area map indicating a position of the current tracing camera on the display apparatus; and
displaying the live video of each of the plurality of cameras on the display apparatus and highlighting each live video of the current tracing camera and the successive camera in an identifiable manner different from live videos of other cameras,
wherein in each step of displaying the monitoring area map and the live video of the camera on the display apparatus, the monitoring area map and the live video of the camera in different display windows are displayed on the display apparatus, and the position of the current tracing camera on the monitoring area map and each highlighted live video of the current tracing camera and the successive camera are updated corresponding to switching of the current tracing camera.
